(19) United States
(12) Patent Application Publication
(10) Pub. No.: US 2025/0298529 A1
(43) Pub. Date: Sep. 25, 2025

(54) STORAGE DEVICE SUPPORTING LIVE MIGRATION OPERATION AND OPERATING METHOD OF THE STORAGE DEVICE

(71) Applicant: SK hynix Inc, Icheon-si (KR)

(72) Inventors: Byoung Min JIN, Icheon-si (KR); Ku Ik KWON, Icheon-si (KR); Gyu Yeul HONG, Icheon-si (KR)

(21) Appl. No.: 18/799,466

(22) Filed: Aug. 9, 2024

(30) Foreign Application Priority Data
Mar. 25, 2024 (KR) 10-2024-0040289

(51) Int. Cl. G06F 3/06

(52) U.S. Cl. CPC G06F 3/0647; G06F 3/0604; G06F 3/0683

(57) ABSTRACT

A storage device comprising: a memory, and a controller configured to perform a migration operation of migrating kept data units stored in the memory to an external storage device, wherein the controller selects updated data units, among N data units included in a kept data group for which an update check request has been made, by determining whether each of the N data units included in the kept data group has been updated when receiving an update check request for the plurality of kept data groups each comprising N kept data units, performs a selection operation of storing the updated data units in an update cache, predicts a kept data group for which an update check request is to be made next by analyzing the N data units, and performs a selection operation on the kept data group for which the update check request is to be made next.

### CROSS-REFERENCE TO RELATED APPLICATION

This application claims priority under 35 U.S.C. § 119 to Korean Patent Application No. 10-2024-0040289 filed on Mar. 25, 2024, in the Korean Intellectual Property Office, which is incorporated herein by reference in its entirety.

### BACKGROUND

### 1. Field

Exemplary embodiments relate to a storage device, and particularly, to a storage device supporting a live migration operation and an operating method of the storage device.

### 2. Discussion of the Related Art

A storage device is a device in which data are stored based on a request from a mobile terminal, such as a computer, a smartphone, or a tablet PC, or an external device, such as various electronic devices.

The storage device may further include a controller for controlling memory (e.g., volatile memory/nonvolatile memory). The controller may receive a command from the external device, and may execute or control operations for reading, writing, or erasing data with respect to memory included in the storage device, based on the received command.

The storage device may select some or all of data stored in the storage device based on a request from a host, and may migrate the some or all of the data to another storage device. In particular, during the migration operation, the storage device may permit access according to the request from the host. This is called a live migration operation.

In the live migration operation, a scan operation of checking whether data already copied to another storage device have been updated based on the request from the host, and a copy operation of copying the updated data checked in the scan operation again, may be performed because access according to the request from the host needs to be permitted while the data of the storage device are migrated to another storage device.

The scan operation and the copy operation may be repeated at least once during the live migration operation. Furthermore, the last scan operation and copy operation included in the live migration operation may be performed in an interval in which the update of the data of the storage device is prohibited, that is, a down-time interval.

In this case, the down-time interval may be an interval that needs to be unconditionally entered at the end of the live migration operation. In order to improve the quality of a service that is provided by the host, the length of the down-time interval needs to be minimized. To this end, the time taken for the last scan operation that is performed in the down-time interval needs to be minimized.

### SUMMARY

Various embodiments are directed to providing a storage device capable of minimizing the length of a down-time interval by minimizing the time taken for a scan operation when data stored in the storage device are migrated to another storage device through a live migration operation, and an operating method of the storage device. Technical objects to be achieved by the present disclosure are

not limited to the aforementioned object, and the other objects not described above may be evidently understood from the following description by a person having ordinary knowledge in the art to which the present disclosure pertains.

An aspect of an embodiment in the disclosure, a storage device may include: a memory in which kept data units are stored; and a controller configured to perform a migration operation of migrating the kept data units to an external storage device based on a request from a host, wherein the controller may select updated data units, from a plurality of kept data groups with an N data units included in a kept data group for which an update check request has been made, by determining whether each of the N data units included in the kept data group has been updated when receiving an update check request for the plurality of kept data groups from the host, may perform a selection operation of storing the updated data units in an update cache, may predict a kept data group for which an update check request is to be made next by the host, among the plurality of kept data groups, by analyzing the N data units, and may perform a selection operation on the kept data group for which the update check request is to be made next, wherein N may be a natural number equal to or greater than 2.

An aspect of an embodiment in the disclosure, a storage device may include: a memory in which kept data units are stored; and a controller configured to perform a migration operation of migrating the kept data units to an external storage device based on a request from a host, wherein the controller may store address mapping information for physical addresses of the memory corresponding to the kept data units in the memory, when receiving an update check request for a plurality of kept data groups each comprising N data units from the host, may load first address mapping information for a kept data group for which an update check request has been made, selects updated data units by determining whether each of the N data units included in the kept data group for which the update check request has been made based on the first address mapping information, and performs a selection operation of storing the updated data units in an update cache, and may predict a kept data group for which an update check request is to be made next by the host, by analyzing the first address mapping information, and loads second address mapping information for the kept data group for which the update check request is to be made next, from the memory, wherein N may be a natural number equal to or greater than 2.

The controller may start an execution of a selection operation for the kept data group for which the update check request is to be made next, before the next update check request is received, after an execution of a selection operation for the kept data group for which the update check request has been made is started.

The controller may manage each of the kept data units in units of a first size based on the address mapping information, and may manage each of the updated data units that have been stored in the update cache in units of a second size that is greater than the first size by setting the updated data units that have been merged by a predetermined number as a transmission data unit based on transmission mapping information.

The controller may perform a copy operation of migrating the transmission data unit to the external storage device, and may repeatedly perform an update processing loop comprising a plurality of selection operations and copy operations for the plurality of kept data groups until the migration operation is completed.

The controller may set a first selection operation, among the plurality of selection operations included in a first update processing loop during the update processing loop that is repeatedly performed, and sets remaining selection operations except the first selection operation as a second selection operation, and may set a plurality of selection operations included in a second update processing loop that is repeated until the migration operation is completed after the first update processing loop, during the update processing loop that is repeatedly performed.

The controller may set a first selection operation, among the plurality of selection operations included in each of the update processing loops that are repeatedly performed, and may set remaining selection operations except the first selection operation as a second selection operation.

The controller may determine an update check prediction order and a second start logical address and a second end logical address that are included in the second address mapping information by analyzing an update check order that has been applied to the selection operation for the kept data group for which the update check request has been made based on a first start logical address and a first end logical address that are included in the first address mapping information, and may perform the selection operation on the kept data group for which the update check request is to be made next, which corresponds to the second start logical address and the second end logical address, based on the update check prediction order.

An aspect of an embodiment in the disclosure, an operating method of a storage device configured to perform a migration operation of migrating kept data units that have been stored in internal memory to an external storage device based on a request from a host, the operating method may include: selecting, when receiving an update check request for a plurality of kept data groups each comprising an N data units from the host, updated data units, from among the N data units, by determining whether each of the N data units included in a kept data group for which the update check request has been made, among the plurality of kept data groups and performing a selection operation of storing the updated data units in an update cache; predicting a kept data group for which an update check request is to be made next by the host, from among the plurality of kept data groups, by analyzing the N data units; and performing the selection operation on the kept data group for which the update check request is to be made next, wherein N may be a natural number equal to or greater than 2.

According to this technology, when data stored in the storage device are migrated to another storage device through a live migration operation, information of a second scan operation for which a request from a host has been scheduled may be checked based on the results of the analysis of a first scan operation that is performed based on a request from the host, and the execution of the second scan operation may be started prior to a request from the host.

Accordingly, the time taken for the second scan operation which may be started prior to the request from the host may be shorter than the time taken for the first scan operation that starts to be executed based on the request from the host, on the basis of timing at which the scan operation is requested by the host. In this case, a scan operation included in a down-time interval may be set as the second scan operation because at least one scan operation and at least one copy operation are performed before the down-time interval is entered in the live migration operation. Accordingly, the length of the down-time interval can be minimized.

### BRIEF DESCRIPTION OF THE DRAWINGS

FIG. 1 is a diagram describing a live migration operation that is performed in a storage device according to an embodiment of the present disclosure.

FIGS. 2A to 2F are diagrams describing an example of a live migration operation that is performed in a storage device according to an embodiment of the present disclosure disclosed in FIG. 1. FIGS. 3A to 3E are diagrams describing another example of a

live migration operation that is performed in a storage device according to an embodiment of the present disclosure disclosed in FIG. 1.

FIG. 4 is a diagram describing the order of a live migration operation that is performed in a storage device according to an embodiment of the present disclosure.

FIG. 5 is a diagram describing a schematic construction of a storage device according to an embodiment of the present disclosure.

### DETAILED DESCRIPTION

Various embodiments of the present disclosure are described below with reference to the accompanying drawings. Elements and features of the disclosure, however, may be configured or arranged differently to form other embodiments, which may be variations of any of the disclosed embodiments.

In this disclosure, references to various features (e.g., elements, structures, modules, components, steps, operations, characteristics, etc.) included in “one embodiment,” “example embodiment,” “an embodiment,” “another embodiment,” “some embodiments,” “various embodiments,” “other embodiments,” “alternative embodiment,” and the like are intended to mean that any such features are included in one or more embodiments of the present disclosure, but may or may not necessarily be combined in the same embodiments.

In this disclosure, the terms “comprise,” “comprising,” “include,” and “including” are open-ended. As used in the appended claims, these terms specify the presence of the stated elements and do not preclude the presence or addition of one or more other elements. The terms in a claim do not foreclose the apparatus from including additional components (e.g., an interface unit, circuitry, etc.).

In this disclosure, various units, circuits, or other components may be described or claimed as “configured to” perform a task or tasks. In such contexts, “configured to” is used to connote structure by indicating that the blocks/units/circuits/components include structure (e.g., circuitry) that performs one or more tasks during operation. As such, the block/unit/circuit/component can be said to be configured to perform the task even when the specified block/unit/circuit/component is not currently operational (e.g., is not turned on nor activated). The block/unit/circuit/component used with the “configured to” language includes hardware, such as for example, circuits, memory storing program instructions executable to implement the operation, etc. Additionally, “configured to” can include a generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that implement or perform one or more tasks.

As used in the disclosure, the term ‘circuitry’ or ‘logic’ refers to all of the following: (a) hardware-only circuit implementations (such as implementations in only analog and/or digital circuitry) and (b) combinations of circuits and software (and/or firmware), such as (as applicable): (i) to a combination of processor(s) or (ii) to portions of processor(s)/software (including digital signal processor(s)), software, and memory (ies) that work together to cause an apparatus, such as a mobile phone or server, to perform various functions and (c) circuits, such as a microprocessor(s) or a portion of a microprocessor(s), that require software or firmware for operation, even if the software or firmware is not physically present. This definition of ‘circuitry’ or ‘logic’ applies to all uses of this term in this application, including in any claims. As a further example, as used in this application, the term “circuitry” or “logic” also covers an implementation of merely a processor (or multiple processors) or a portion of a processor and its (or their) accompanying software and/or firmware. The term “circuitry” or “logic” also covers, for example, and if applicable to a particular claim element, an integrated circuit for a storage device.

As used herein, the terms “first,” “second,” “third,” and so on are used as labels for nouns that the terms precede, and do not imply any type of ordering (e.g., spatial, temporal, logical, etc.). The terms “first” and “second” do not necessarily imply that the first value must be written before the second value. Further, although the terms may be used herein to identify various elements, these elements are not limited by these terms. These terms are used to distinguish one element from another element that otherwise have the same or similar names. For example, a first circuitry may be distinguished from a second circuitry.

Further, the term “based on” is used to describe one or more factors that affect a determination. This term does not foreclose additional factors that may affect a determination. That is, a determination may be solely based on those factors or based, at least in part, on those factors. For example, the phrase “determine A based on B.” While in this case, B is a factor that affects the determination of A, such a phrase does not foreclose the determination of A from also being based on C. In other instances, A may be determined based solely on B.

Herein, an item of data, a data item, a data entry or an entry of data may be a sequence of bits. For example, the data item may include the contents of a file, a portion of the file, a page in memory, an object in an object-oriented program, a digital message, a digital scanned image, a part of a video or audio signal, metadata or any other entity which can be represented by a sequence of bits. According to an embodiment, the data item may include a discrete object. According to another embodiment, the data item may include a unit of information within a transmission packet between two different components.

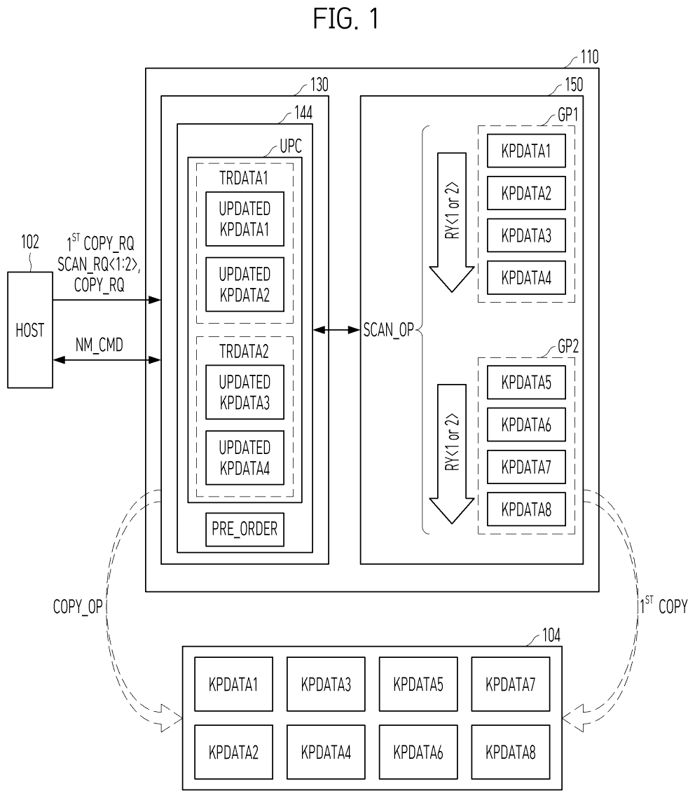

FIG. 1 is a diagram describing a live migration operation that is performed in a storage device according to an embodiment of the present disclosure.

Referring to FIG. 1, a data processing device according to an embodiment of the present disclosure may include a storage device 110, a host 102, and an external storage device 104.

The storage device 110 may include a memory device 150 and a controller 130. The controller 130 may include internal memory 144.

The memory device 150 may be a volatile memory device or a nonvolatile memory device for storing data.

Specifically, the memory device 150 may store kept data units KPDATA1, KPDATA2, KPDATA3, KPDATA4, KPDATA5, KPDATA6, KPDATA7, and KPDATA8. The kept data units KPDATA1, KPDATA2, KPDATA3, KPDATA4, KPDATA5, KPDATA6, KPDATA7, and KPDATA8 may be stored in the memory device 150 based on a request from the host 102. For example, as illustrated in FIG. 1, the memory device 150 may be in the state in which the eight kept data units KPDATA1, KPDATA2, KPDATA3, KPDATA4, KPDATA5, KPDATA6, KPDATA7, and KPDATA8. have been stored in the memory device 150.

The controller 130 may control the memory device 150 in order to perform operations, such as read, program, and erase corresponding to a command NM_CMD that is received from the host 102, and may control the memory device 150 in order to independently operate the storage device 110 regardless of a command that is received from an external device, such as the host 102.

Specifically, the controller 130 may store the kept data units KPDATA1, KPDATA2, KPDATA3, KPDATA4, KPDATA5, KPDATA6, KPDATA7, and KPDATA8 in the memory device 150 based on a request from the host 102. The controller 130 may store address mapping information for the kept data units KPDATA1, KPDATA2, KPDATA3, KPDATA4, KPDATA5, KPDATA6, KPDATA7, and KPDATA8 in the memory device 150. The address mapping information may mean mapping information between a logical address that is used in the host 102 and a physical address indicative of a physical area within the memory device 150. That is, the controller 130 may generate address mapping information in which physical addresses of the memory device 150, which correspond to the kept data units KPDATA1, KPDATA2, KPDATA3, KPDATA4, KPDATA5, KPDATA6, KPDATA7, and KPDATA8, have been mapped to logical addresses of the host 102, and may then store the generated address mapping information in the memory device 150. The controller 130 may perform a migration operation of migrating the kept data units KPDATA1, KPDATA2, KPDATA3, KPDATA4, KPDATA5, KPDATA6, KPDATA7, and KPDATA8 that have been stored in the memory device 150 to the external storage device 104 based on a request from the host 102. In particular, the controller 130 may perform a live migration operation of permitting access to the kept data units KPDATA1, KPDATA2, KPDATA3, KPDATA4, KPDATA5, KPDATA6, KPDATA7, and KPDATA8, that is, a read operation, a write operation, or an erase operation based on a request from the host 102 while performing a migration operation of migrating the kept data units KPDATA1, KPDATA2, KPDATA3, KPDATA4, KPDATA5, KPDATA6,KPDATA7, and KPDATA8, which have been stored in the memory device 150, to the external storage device 104.

For reference, it may be seen that FIG. 1 illustrates that the eight kept data units KPDATA1, KPDATA2, KPDATA3, KPDATA4, KPDATA5, KPDATA6, KPDATA7, and KPDATA8 have been stored in the memory device 150 and illustrates a migration operation of migrating all of the eight kept data units KPDATA1, KPDATA2, KPDATA3, KPDATA4, KPDATA5, KPDATA6, KPDATA7, and KPDATA8 stored in the memory device 150 to the external storage device 104. However, this is merely for convenience of description. For example, the controller 130 may perform a migration operation of selecting only some of data that have been stored in the memory device 150 and migrating the some of the data to the external storage device 104.

In FIG. 1 data appear to be directly migrated between the storage device 110 and the external storage device 104, but this is only for convenience of description. That is, the storage device 110 and the external storage device 104 may have a form or structure in which the storage device 110 and the external storage device 104 have been connected to the host 102 through different interfaces. A migration operation may be performed through the host 102.

The internal memory 144 included in the controller 130 may be operating memory of the storage device 110 and the controller 130, and may store data for the driving of the storage device 110 and the controller 130. In particular, the internal memory 144 may include an update cache UPC for temporarily storing updated data units UPDATED KPDATA1, UPDATED KPDATA2, UPDATED KPDATA3, and UPDATED KPDATA4 based on a request from the host 102, among the kept data units KPDATA1, KPDATA2, KPDATA3, KPDATA4, KPDATA5, KPDATA6, KPDATA7, and KPDATA8 that have been stored in the memory device 150, while a live migration operation is performed.

When starting a live migration operation, the controller 130 may perform a first copy operation 1^{ST} COPY of copying all of the kept data units KPDATA1, KPDATA2, KPDATA3, KPDATA4, KPDATA5, KPDATA6, KPDATA7, and KPDATA8 that have been stored in the memory device 150 to the external storage device 104 based on a request 1^{ST} COPY_RQ from the host 102.

The controller 130 may permit an access operation for some data units of the kept data units KPDATA1, KPDATA2, KPDATA3, KPDATA4, KPDATA5, KPDATA6, KPDATA7, and KPDATA8 that have been stored in the memory device 150 based on the request NM_CMD of the host 102 in an interval in which the first copy operation 1ST COPY is performed because the live migration operation is being performed.

For this reason, when the first copy operation 1ST COPY has been completed, some of data units that have been stored in the external storage device 104 may be invalid data units. For example, after the first data unit KPDATA1 is copied to the external storage device 104 through the first copy operation 1^{ST} COPY , the memory device 150 may be in the state in which the first data unit KPDATA1 has been updated and stored in the memory device 150, while the first copy operation 1^{ST} COPY is performed. Accordingly, the first data unit KPDATA1 that has been copied to the external storage device 104 may be an invalid state.

Accordingly, after the first copy operation 1^{ST} COPY is completed, the controller 130 may check the updated data units UPDATED KPDATA1, UPDATED KPDATA2, UPDATED KPDATA3, and UPDATED KPDATA4, among the kept data units KPDATA1, KPDATA2, KPDATA3, KPDATA4, KPDATA5, KPDATA6, KPDATA7, and KPDATA8, by performing a scan operation SCAN_OP based on a request (SCAN_RQ, COPY_RQ from the host 102), may store the updated data units UPDATED KPDATA1, UPDATED KPDATA2, UPDATED KPDATA3, and UPDATED KPDATA4 in the update cache UPC, and may then perform a copy operation COPY_OP of copying the data units that have been stored in the update cache UPC to the external storage device 104 again.

As described above, the controller 130 may perform the scan operation SCAN_OP and the copy operation COPY_OP based on a request from the host 102 after the first copy operation 1^{ST} COPY for a live migration operation. The controller 130 may permit an access operation for some data units, among the kept data units KPDATA1, KPDATA2, KPDATA3, KPDATA4, KPDATA5, KPDATA6, KPDATA7, and KPDATA8 that have been stored in the memory device 150, based on the request NM_CMD of the host 102 even in an interval in which the scan operation SCAN_OP and the copy operation COPY_OP are performed due to the live migration operation. For this reason, at a time at which the first scan operation SCAN_OP and the copy operation COPY_OP are completed, some of the data units that have been stored in the external storage device 104 may be invalid data units.

Accordingly, in order to permit access according to a request from the host 102, the controller 130 may repeatedly perform the scan operation SCAN_OP and the copy operation COPY_OP at least once in the interval in which the first copy operation 1^{ST} COPY is executed. In this case, one scan operation SCAN_OP and one copy operation COPY_OP may be operations which may be bundled and performed, which may be named an “update processing loop”. That is, the controller 130 may repeatedly perform at least one update processing loop after the execution of the first copy operation 1^{ST} COPY is completed in order to permit access according to a request from the host 102 in the interval in which the first copy operation 1^{ST} COPY is executed.

The completion of a migration operation may be impossible because an updated data unit may be generated if an access operation for the memory device 150 is permitted based on the request NM_CMD of the host 102 while an update processing loop is performed. For this reason, when checking that the number of data units that have been stored in the update cache UPC is less than a critical number after the scan operation SCAN_OP is performed, the controller 130 may complete a migration operation by entering a down-time mode in which the update of the kept data units KPDATA1, KPDATA2, KPDATA3, KPDATA4, KPDATA5, KPDATA6, KPDATA7, and KPDATA8 that have been stored in the memory device 150 is prohibited, and further perform one update processing loop. In this case, the controller 130 may enter the down-time mode based on a request to enter the down-time mode from the host 102. For example, after performing the scan operation SCAN_OP, the controller 130 may transmit information with regard to whether the checked number of data units that have been stored in the update cache UPC is less than a critical number to the host 102. The host 102 may let the controller 130 enter the down-time mode. For reference, in an embodiment of the present disclosure, a mode in which the update of the kept data units KPDATA1, KPDATA2, KPDATA3, KPDATA4, KPDATA5, KPDATA6, KPDATA7, and KPDATA8 that have been stored in the memory device 150 is permitted will be defined as a live-time mode, which has a meaning that is opposite to the down-time mode.

In other words, the controller 130 may complete a migration operation by entering a live-time mode, when starting the migration operation, and performing the first copy operation 1^{ST} COPY and at least one update processing loop, and then entering a down-time mode and performing one update processing loop.

In the interval in which the scan operation SCAN_OP included in the migration operation is executed, the controller 130 may select the updated data units UPDATED KPDATA1, UPDATED KPDATA2, UPDATED KPDATA3, and UPDATED KPDATA4, from among the kept data units KPDATA1, KPDATA2, KPDATA3, KPDATA4, KPDATA5, KPDATA6, KPDATA7, and KPDATA8 that have been stored in the memory device 150, and may store the updated data units UPDATED KPDATA1, UPDATED KPDATA2, UPDATED KPDATA3, and UPDATED KPDATA4 in the update cache UPC.

More specifically, the controller 130 may classify the kept data units KPDATA1, KPDATA2, KPDATA3, KPDATA4, KPDATA5, KPDATA6, KPDATA7, and KPDATA8 that have been stored in the memory device 150 into a plurality of groups GP1 and GP2 each including an N number of kept data units. In this case, N may be a natural number equal to or greater than 2. For example, as illustrated in FIG. 1, the controller 130 may set N to 4 and classify the eight kept data units KPDATA1, KPDATA2, KPDATA3, KPDATA4, KPDATA5, KPDATA6, KPDATA7, and KPDATA8 that have been stored in the memory device 150 into two groups GP1 and GP2, each including four kept data units.

In the interval in which the scan operation SCAN_OP included in the migration operation is executed, when receiving an update check request, that is, a scan request SCAN_RQ<1:2>, from the host 102, the controller 130 may perform a selection operation of selecting the updated data units UPDATED KPDATA1, UPDATED KPDATA2, UPDATED KPDATA3, and UPDATED KPDATA4, which are among N data units included in the plurality of groups GP1 and GP2 for which a check request has been made, and storing the selected data units in the update cache UPC. In this case, the controller 130 may perform a plurality of selection operations on each of the plurality of groups GP1 and GP2 in one scan operation SCAN_OP because the selection operation may be performed on each of the plurality of groups GP1 and GP2.

For reference, the scan request SCAN_RQ<1:2> that is received from the host 102 may be an operation of requesting the controller 130 to check updated data units from among the kept data units KPDATA1, KPDATA2, KPDATA3, KPDATA4, KPDATA5, KPDATA6, KPDATA7, and KPDATA8 that have been stored in the memory device 150. Accordingly, the “scan request” and the “update check request” that are described in the following description may mean request operations that are used with the same meaning.

For example, the controller 130 may select updated data units by checking each of the four data units KPDATA1, KPDATA2, KPDATA3, and KPDATA4 that have been included in a first group GP1 corresponding to the first scan request from the host 102, and may store the updated data units in the update cache UPC. Likewise, the controller 130 may select updated data units by checking each of the four data units KPDATA5, KPDATA6, KPDATA7, and KPDATA8 that have been included in a second group GP2 corresponding to the second scan request from the host 102, and may store the updated data units in the update cache UPC.

In the interval in which the scan operation SCAN_OP included in the migration operation is executed, when receiving the scan request SCAN_RQ<1:2> from the host 102, the controller 130 may load first address mapping information for a group (e.g., from among the plurality of groups GP1 and GP2) for which an update check request has been made,, from the memory device 150. The controller 130 may store the first address mapping information in the internal memory 144 of the controller 130. The controller 130 may perform a selection operation of selecting the updated data units UPDATED KPDATA1, UPDATED KPDATA2, UPDATED KPDATA3, and UPDATED KPDATA4, from among N data units included in the group for which the update check request has been made by the host 102, based on the first address mapping information loaded onto the internal memory 144 of the controller 130, and storing the selected data units in the update cache UPC. In this case, the controller 130 may perform a plurality of selection operations on each of the plurality of groups GP1 and GP2 in one scan operation SCAN_OP because the selection operation may be performed on each of the plurality of groups GP1 and GP2.

For example, when an update check for the first group GP1, from among the plurality of groups GP1 and GP2, is requested by the host 102, the controller 130 may load first address mapping information for the first group GP1 (which is included in the address mapping information stored in the memory device 150) from the memory device 150, and may store the first address mapping information in the internal memory 144 of the controller 130. The controller 130 may select updated data units, among the four data units KPDATA1, KPDATA2, KPDATA3, and KPDATA4 included in the first group GP1, based on the first address mapping information for the first group GP1 that has been stored in the internal memory 144 of the controller 130, and may store updated data units in the update cache UPC.

The controller 130 may set the scan request SCAN_RQ<1:2> to be received from the host 102 as any one of a first scan request SCAN_RQ1 and a second scan request SCAN_RQ2. This depends on whether the scan request SCAN_RQ<1:2> is a scan request received in accordance with any one of selection operations in a scan operation that is included in an update processing loop of a migration operation. In addition, the controller 130 may set a selection operation corresponding to the first scan request SCAN_RQ1 to be received from the host 102 as a first selection operation RY1, and may set a selection operation corresponding to the second scan request SCAN_RQ2 to be received from the host 102 as a second selection operation RY2.

The controller 130 may set one of all selection operations that are performed in a migration operation as the first selection operation RY1, and may set the remaining selection operations as the second selection operation RY2.

Specifically, the controller 130 may set, as the first selection operation RY1, the first selection operation from among a plurality of selection operations for the plurality of groups GP1 and GP2, which are included in the scan operation SCAN_OP of an update processing loop that is performed for the first time after a migration operation is started (i.e., the scan operation SCAN_OP of an update processing loop that is performed for the first time in the live-time mode).

The controller 130 may set, as the second selection operation RY2, the remaining selection operations after the first selection operation, from among the plurality of selection operations for the plurality of groups GP1 and GP2, which are included in the scan operation SCAN_OP of the update processing loop that is performed for the first time. The controller 130 may set, as the second selection operation RY2, each of a plurality of selection operations for the plurality of groups GP1 and GP2, which are included in each of scan operations of the remaining other update processing loops (also including an update processing loop that is performed once in the down-time mode) that are repeated until the migration operation is completed after the update processing loop that is performed for the first time.

That is, the controller 130 may set, as the first scan request SCAN_RQ1, a scan request to be received from the host 102 in order to perform the first selection operation in the scan operation SCAN_OP of the update processing loop that is performed for the first time after the migration operation is started. The controller 130 may set, as the second scan request SCAN_RQ2, all of scan requests to be received from the host 102 in order to perform the remaining selection operations, except for the scan request corresponding to the first selection operation of the first update processing loop after the migration operation is started.

In another embodiment, the controller 130 may set only one selection operation in one update processing loop as the first selection operation RY1 and set all of the remaining selection operations as the second selection operation RY2, when the update processing loop is repeated in a migration operation.

Specifically, when the scan operation SCAN_OP of an update processing loop that is repeated at least twice after a migration operation is started, that is, a scan operation of each of an update processing loop that is performed at least once in the live-time mode and an update processing loop that is performed once in the down-time mode is performed, the controller 130 may set the first selection operation included in a corresponding scan operation, as the first selection operation RY1.

The controller 130 may set, as the second selection operation RY2, the remaining selection operations except for the first selection operation, among a plurality of selection operations for the plurality of groups GP1 and GP2, which are included in a corresponding scan operation, whenever the scan operation SCAN_OP of an update processing loop that is repeated at least twice after a migration operation is started is performed.

That is, the controller 130 may set, as the first scan request SCAN_RQ1, a scan request to be received from the host 102 in order to perform the first selection operation, among the plurality of selection operations for the plurality of groups GP1 and GP2, which are included in each of scan operations of the update processing loop that is repeated at least twice after the migration operation is started. The controller 130 may set, as the second scan request SCAN_RQ2, a scan request to be received from the host 102 in order to perform the remaining selection operations except the first selection operation.

As in the aforementioned embodiment, it may be seen that the first selection operation RY1 corresponding to the first scan request SCAN_RQ1 from the host 102 is always performed earlier than the second selection operation RY2 corresponding to the second scan request SCAN_RQ2 from the host 102.

When a scan request to be received from the host 102 is set as the first scan request SCAN_RQ1, the controller 130 may perform the first selection operation RY1 of checking whether each of N data units included in a group corresponding to the first scan request SCAN_RQ1, among the plurality of groups GP1 and GP2, has been updated according to an update check order included in the first scan request SCAN_RQ1, after the first scan request SCAN_RQ1 is received from the host 102.

In this case, during the execution of the first selection operation RY1 or after the execution of the first selection operation RY1 is completed, the controller 130 may predict a group for which a check request will be made next by the host 102 by analyzing N data units included in a group for which an update check request has now been made by the host 102, among the plurality of groups GP1 and GP2, that is, by analyzing an update check order of the group for which the update check request has now been made, and may store information with regard to the predicted group for which the update check request has been made in the internal memory 144 as prediction information PRE_ORDER.

During the execution of the first selection operation RY1 or after the execution of the first selection operation RY1 is completed, the controller 130 may predict a group for which a check request will be made next by the host 102 by analyzing first address mapping information corresponding to a group for which an update check request has now been made by the host 102, among the plurality of groups GP1 and GP2, that is, by analyzing an update check order of the group for which the update check request has now been made, and may store information with regard to the predicted group for which the update check request has been made in the internal memory 144 as the prediction information PRE_ORDER.

According to an embodiment, the controller 130 may store the prediction information PRE_ORDER in the internal memory 144, but this is merely for some embodiments. In other embodiments, the controller 130 may store the prediction information PRE_ORDER in another storage space other than the internal memory 144.

A time at which the first scan request SCAN_RQ1 is received from the host 102 may be defined as a first timing. When a scan request to be received from the host 102 is set as the second scan request SCAN_RQ2, the controller 130 may start the execution of the second selection operation RY2 corresponding to the second scan request SCAN_RQ2 with respect to a group for which an update check request will be made, which is included in the prediction information PRE_ORDER stored in the internal memory 144 of the controller 130, at a second timing, which is a time before the second scan request SCAN_RQ2 is received from the host 102 and is later than the first timing.

That is, after the execution of the first selection operation RY1 for a group for which an update check request has now been made is started based on the first scan request SCAN_RQ1 received from the host 102 at the first timing, the controller 130 may predict a group for which an update check request will be made next by analyzing an update check order applied to the first scan request SCAN_RQ1 before the second scan request SCAN_RQ2 is received from the host 102, and may store corresponding information in the internal memory 144 of the controller 130 as the prediction information PRE_ORDER. At the second timing, which is later than the first timing, that is, at timing before the second scan request SCAN_RQ2 is received from the host 102, the controller 130 may perform the second selection operation RY2, corresponding to the second scan request SCAN_RQ2, on a group for which an update check request will be made, which is included in the prediction information PRE_ORDER that has been stored in the internal memory 144 of the controller 130. The second selection operation RY2 that is started by the controller 130 at the second timing may continue until the second selection operation RY2 is completed regardless of the reception of the second scan request SCAN_RQ2 from the host 102 during the execution of the second selection operation RY2 (i.e., at an arbitrary timing that is later than the second timing).

The controller 130 may manage each of the kept data units KPDATA1, KPDATA2, KPDATA3, KPDATA4, KPDATA5, KPDATA6, KPDATA7, and KPDATA8 that have been stored in the memory device 150 in units of a first size. The first size may be identical with the size of a page or a multiple of the size of a page. For example, when the controller 130 manages each of the kept data units KPDATA1, KPDATA2, KPDATA3, KPDATA4, KPDATA5, KPDATA6, KPDATA7, and KPDATA8 that have been stored in the memory device 150 in units of a first size, a data unit that is transmitted between the memory device 150 and the controller 130 is also managed in units of the first size, that is, the data unit is mapped in units of the first size. That is, the controller 130 may manage each of the kept data units KPDATA1, KPDATA2, KPDATA3, KPDATA4, KPDATA5, KPDATA6, KPDATA7, and KPDATA8 in units of the first size based on address mapping information.

The controller 130 may manage the updated data units UPDATED KPDATA1, UPDATED KPDATA2, UPDATED KPDATA3, and UPDATED KPDATA4 that have been stored in the update cache UPC through a scan operation in units of a second size that is greater than the first size. The controller 130 may set the updated data units UPDATED KPDATA1, UPDATED KPDATA2, UPDATED KPDATA3, and

UPDATED KPDATA4 as transmission data units TRDATA1 and TRDATA2 in which the updated data units have been merged in a predetermined number. For example, when the controller 130 manages the updated data units UPDATED KPDATA1, UPDATED KPDATA2, UPDA TED KPDATA3, and UPDATED KPDATA4 stored in the update cache UPC in units of the second size, a data unit that is transmitted between the update cache UPC and the external storage device 104 is also managed in units of the second size, that is, the data unit is mapped in units of the second size. That is, the controller 130 may generate transmission mapping information for managing the transmission data units TRDATA1 and TRDATA2 in units of the second size separately from the address mapping information for managing the kept data units KPDATA1, KPDATA2, KPDATA3, KPDATA4, KPDATA5, KPDATA6, KPDATA7, and KPDATA8 in units of the first size.

For example, as illustrated in FIG. 1, in order to set the second size to be twice the first size, the controller 130 may manage the four updated data units UPDATED KPDATA1, UPDATED KPDATA2, UPDATED KPDATA3, and UPDATED KPDATA4 that have been stored in the update cache UPC through a scan operation as two transmission data units TRDATA1 and TRDATA2. This may result from merging the four updated data units into the two transmission data units, which each including two updated data units.

In other words, the controller 130 may store the updated data units UPDATED KPDATA1, UPDATED KPDATA2, UPDATED KPDATA3, and UPDATED KPDATA4 in units of the first size unit, when reading the updated data units UPDATED KPDATA1, UPDATED KPDATA2, UPDATED KPDATA3, and UPDATED KPDATA4 from the memory device 150 and storing the updated data units in the update cache UPC through a scan operation. Thereafter, the controller 130 may set the transmission data units TRDATA1 and TRDATA2 by merging the updated data unit UPDATED KPDATA1, UPDATED KPDATA2, UPDATED KPDATA3, and UPDATED KPDATA4 that have been stored in the update cache UPC by a predetermined number, and may perform a copy operation in the second size unit, that is, may copy the transmission data units TRDATA1 and TRDATA2 that have been stored in the update cache UPC in units of the second size to the external storage device 104.

For reference, in FIG. 1 the data units KPDATA1, KPDATA2, KPDATA3, KPDATA4, KPDATA5, KPDATA6, KPDATA7, and KPDATA8 that have been copied to the external storage device 104 appear to be managed in units of the first size. However, this is for convenience of description, and in other embodiments the controller 130 of the present disclosure may not know in advance in what size unit will be used when the external storage device 104 manages data units.

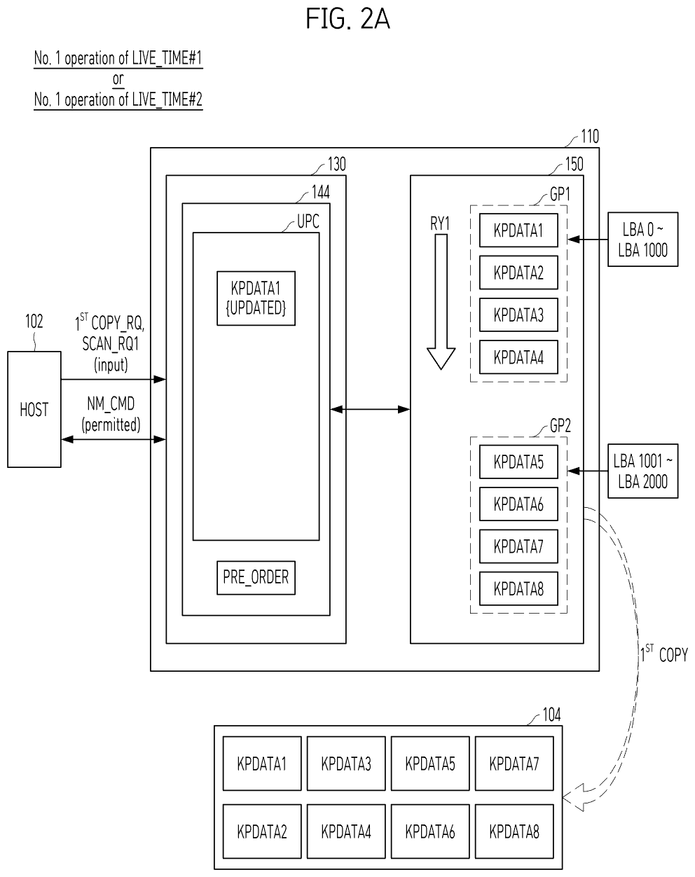

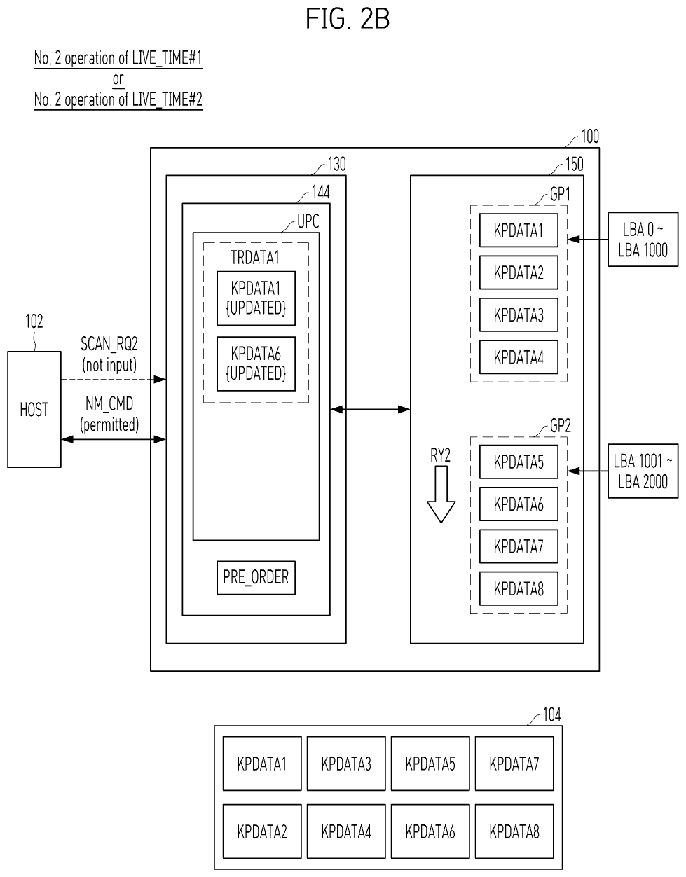

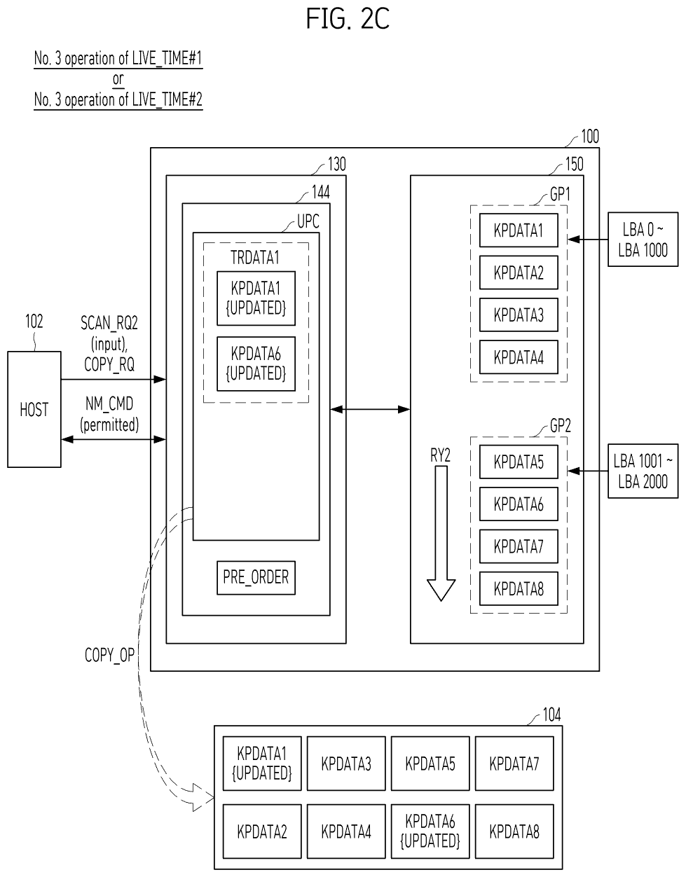

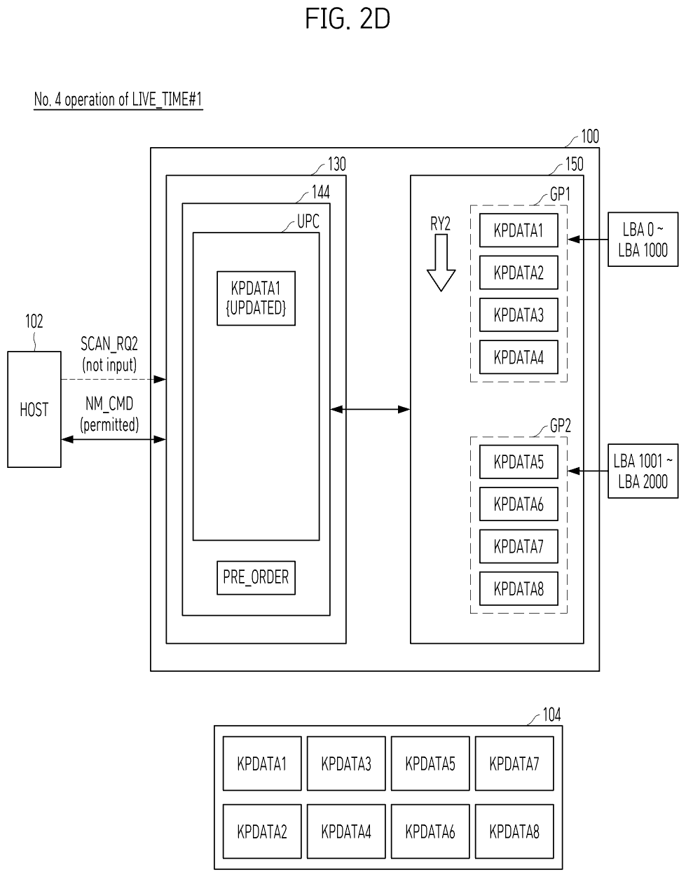

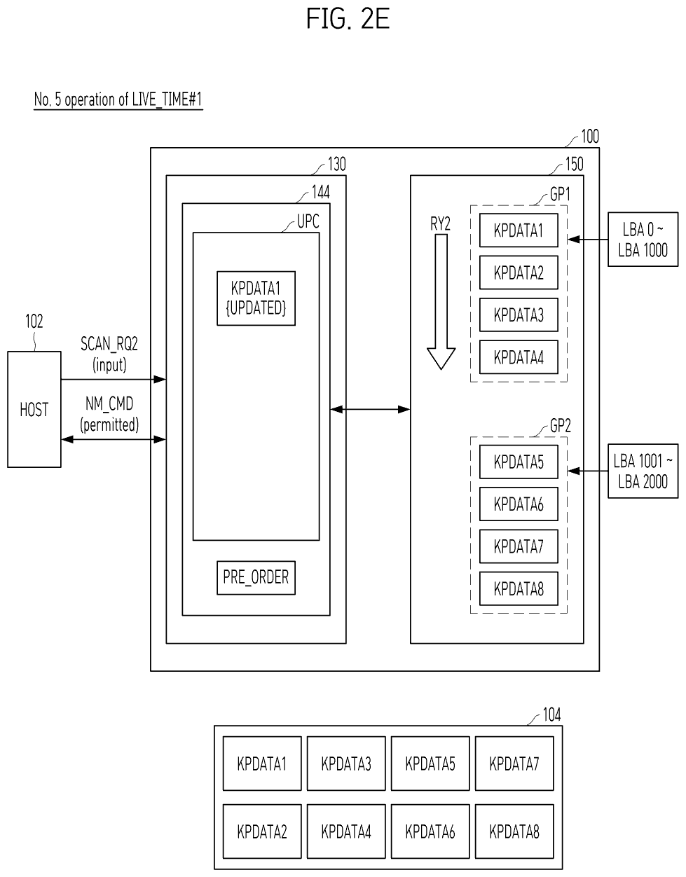

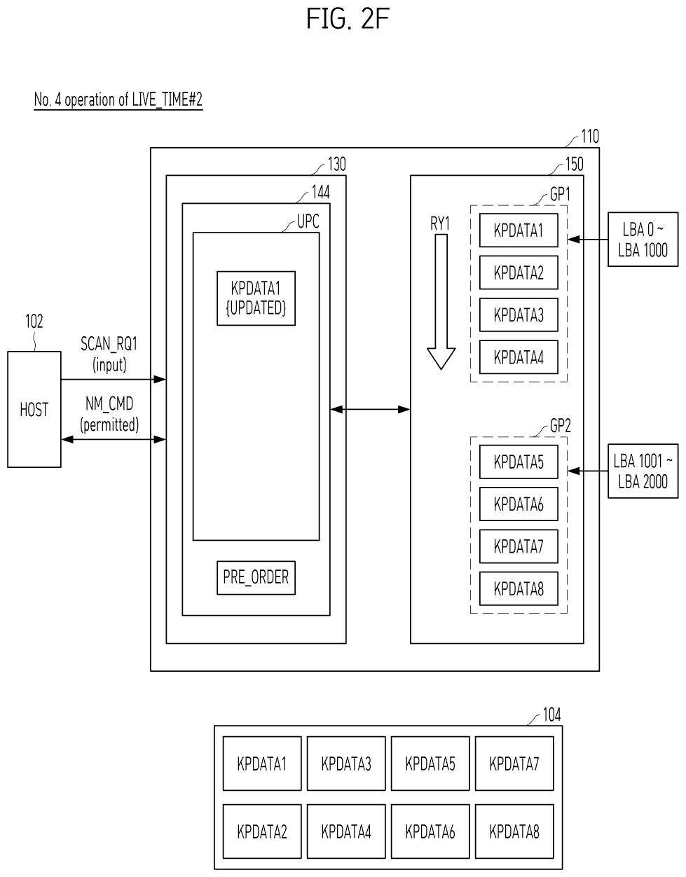

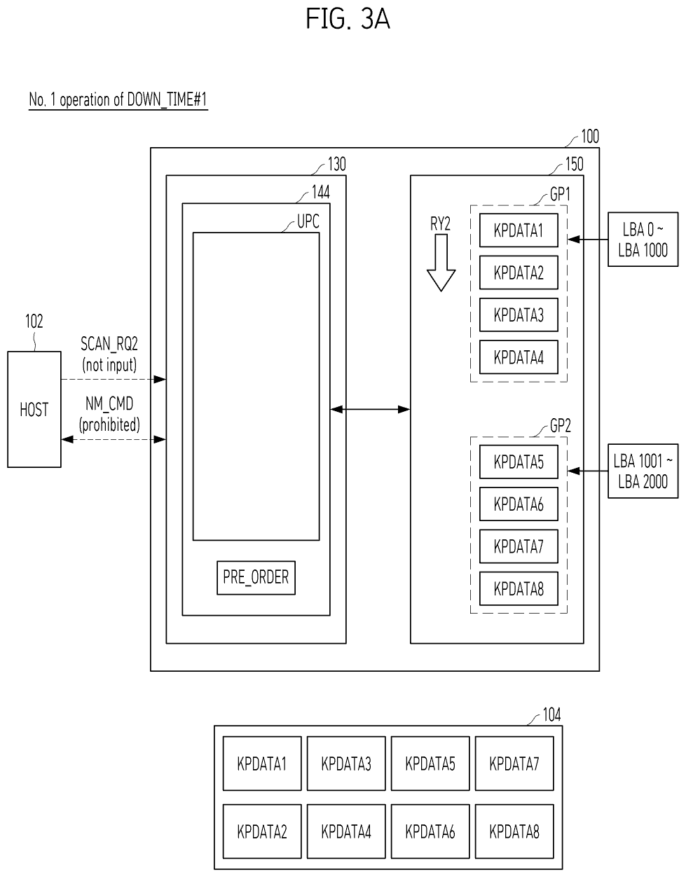

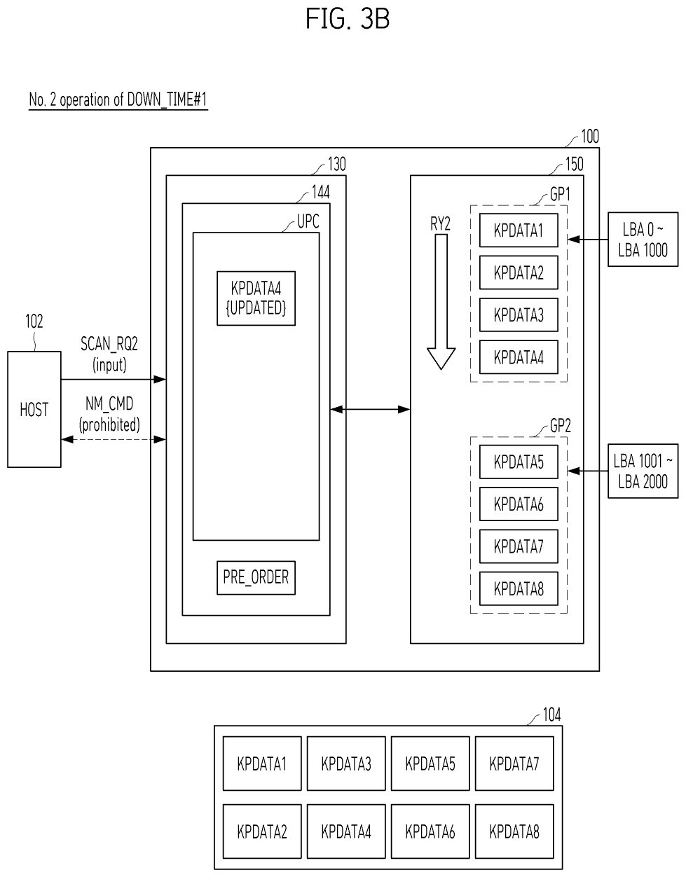

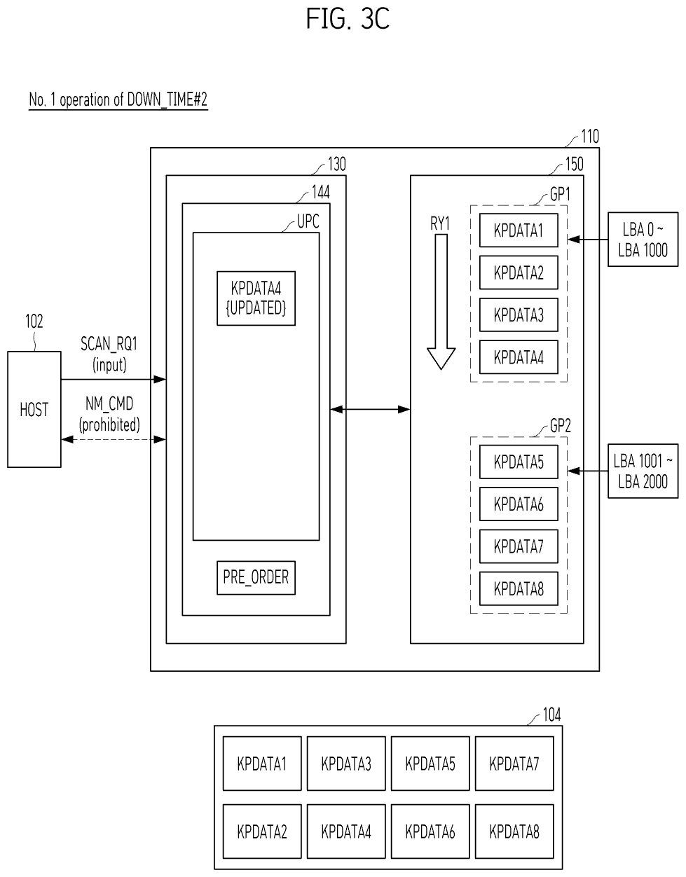

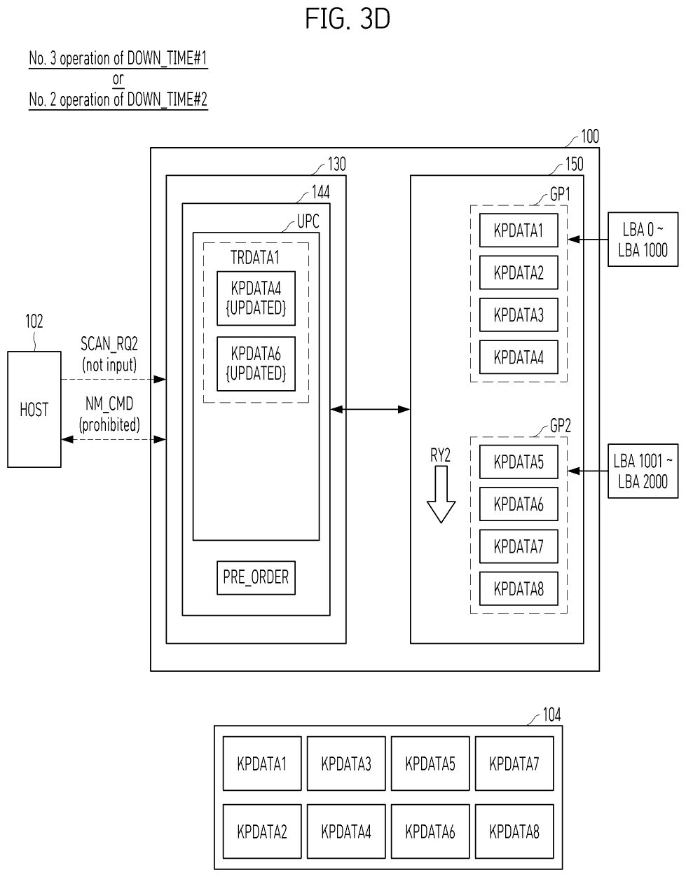

FIGS. 2A to 2F are diagrams describing an example of a live migration operation that is performed in a storage device according to an embodiment of the present disclosure disclosed in FIG. 1.

In an embodiment, FIGS. 2A to 2E refer sequentially to an example of an operation of setting only one selection operation, among all selection operations that are performed in a live-time mode LIVE-TIME#1 of a migration operation, as a first selection operation RY1, and setting all of the remaining selection operations as a second selection operation RY2.

In another embodiment, FIGS. 2A to 2C and 2F refer sequentially to an example of an operation of setting only one selection operation in one update processing loop as the first selection operation RY1 and setting all of the remaining selection operations as the second selection operation RY2 whenever the update processing loop is repeated in a live-time mode LIVE-TIME#2 of the migration operation.

Specifically, referring to FIG. 2A, a controller 130 may perform a first copy operation 1^{ST} COPY of copying all of the kept data units KPDATA1, KPDATA2, KPDATA3, KPDATA4, KPDATA5, KPDATA6, KPDATA7, and KPDATA8 that have been stored in a memory device 150 to an external storage device 104 based on the request 1^{ST} COPY_RQ from a host 102.

After the first copy operation 1^{ST} COPY is completed, the controller 130 may perform the first selection operation RY1 of sequentially checking whether each of the kept data units KPDATA1, KPDATA2, KPDATA3, and KPDATA4 classified as first group GP1 has been updated according to an update check order included in the first scan request SCAN_RQ1, and of storing an updated data unit in the update cache UPC based on a first scan request SCAN_RQ1 received from the host 102. From FIG. 2A, it may be seen that the controller 130 checks that the first kept data unit KPDATA1, among the kept data units KPDATA1, KPDATA2, KPDATA3, and KPDATA4 classified as first group GP1, has been updated through the first selection operation RY1 and stores (KPDATA1{UPDATE}), the first kept data unit KPDATA1, in the update cache UPC.

During the execution of the first selection operation RY1 or after the execution of the first selection operation RY1 is completed, the controller 130 may determine a prediction information PRE_ORDER by analyzing an update check order included in the first scan request SCAN_RQ1, and may store the prediction information PRE_ORDER that has been determined in an internal memory 144 of the controller 130.

The controller 130 may determine the prediction information PRE_ORDER by confirming a first start logical address and a first end logical address that are included in the first scan request SCAN_RQ1, may store the prediction information PRE_ORDER that has been determined in the internal memory 144 of the controller 130. That is, the controller 130 may determine the prediction information PRE_ORDER by confirming the first start logical address and the first end logical address that are included in first address mapping information for a group for which an update check request has been made through the first scan request SCAN_RQ1, and may store the prediction information PRE_ORDER that has been determined in the internal memory 144 of the controller 130.

The controller 130 may confirm physical locations indicated by the first start logical address and the first end logical address included in the first scan request SCAN_RQ1, that is, physical locations corresponding to N data units included in any one selected group, among the plurality of groups GP1 and GP2. Based on the results of the confirmation of the physical locations corresponding to the group for which the update check request has been made through the first scan request SCAN_RQ1, the controller 130 may determine the prediction information PRE_ORDER by predicting physical locations indicated by a second start logical address and a second end logical address to be included in the second scan request SCAN_RQ2, that is, physical locations corresponding to N data units included in the remaining groups except the selected group, among the plurality of groups GP1 and GP2. Based on the results of the confirmation of the first start logical address and the first end logical address included in the first address mapping information for the group for which the update check request has been made through the first scan request SCAN_RQ1, the controller 130 may determine the prediction information PRE_ORDER by predicting the second start logical address and the second end logical address included in second address mapping information for a group for which an update check request will be made next, which will be included in the second scan request SCAN_RQ2.

According to an embodiment, as illustrated in FIG. 2A, the controller 130 may analyze that data units at physical locations indicated by a first start logical address LBA 0 and a first end logical address LBA 1000 that are included in the first scan request SCAN_RQ1 is “KPDATA1” and “KPDATA4”, among the kept data units KPDATA1, KPDATA2, KPDATA3, and KPDATA4 of the first group GP1. Based on the results of the analysis of an update check order included in the first scan request SCAN_RQ1, the controller 130 may predict that “LBA 1001” subsequent to the first end logical address LBA 1000 will become a second start logical address to be included in the second scan request SCAN_RQ2, and may predict that “LBA 2000” will become a second end logical address to be included in the second scan request SCAN_RQ2. That is, the controller 130 may determine the prediction information PRE_ORDER by predicting that data units at physical locations indicated by the second start logical address LBA 1001 and the second end logical address LBA 2000 to be included in the second scan request SCAN_RQ2 that has not yet been received are “KPDATA5” and “KPDATA8”, from among the kept data units KPDATA5, KPDATA6, KPDATA7, and KPDATA8 of the second group GP2.

According to another embodiment, unlike in FIG. 2A, the controller 130 may analyze that data units at physical locations indicated by a first start logical address LBA 2000 and a first end logical address LBA 1001 that are included in the first scan request SCAN_RQ1 are “KPDATA8” and “KPDATA5”, among the kept data units KPDATA5, KPDATA6, KPDATA7, and KPDATA8 of the second group GP2. Based on the results of the analysis of an update check order included in the first scan request SCAN_RQ1, the controller 130 may predict that “LBA 1000” subsequent to the first end logical address LBA 1001 will become a second start logical address to be included in the second scan request SCAN_RQ2 and that “LBA 0” will become a second end logical address to be included in the second scan request SCAN_RQ2. That is, the controller 130 may determine the prediction information PRE_ORDER by predicting that data units at physical locations indicated by the second start logical address LBA 1000 and the second end logical address LBA 0 to be included in the second scan request SCAN_RQ2 that has not yet been received are “KPDATA4” and “KPDATA1”, from among the kept data units KPDATA1, KPDATA2, KPDATA3, and KPDATA4 of the first group GP1.

The controller 130 may permit the access request NM_CMD from the host 102 in an interval in which the first copy operation 1^{ST} COPY and the first selection operation RY1 are performed because the migration operation in FIG. 2A is an operation in the live-time mode LIVE-TIME#1 or LIVE-TIME#2.

Referring to FIG. 2B, in the state in which the second scan request SCAN_RQ2 has not been received, the controller 130 may perform some of the second selection operation RY2 of sequentially checking whether each of two data units KPDATA5 and KPDATA6 corresponding to previous orders in the prediction information PRE_ORDER, among the kept data units KPDATA5, KPDATA6, KPDATA7, and KPDATA8 classified as second group GP2, has been updated, and of storing an updated data unit in the update cache UPC. That is, from FIG. 2B, it may be seen that the controller 130 starts the execution of the second selection operation RY2 with reference to the prediction information PRE_ORDER in a state in which the second scan request SCAN_RQ2 has not been received.

In FIG. 2C, the controller 130 continues to perform the second selection operation RY2 that has already been started in FIG. 2B even after the second scan request SCAN_RQ2 is received. That is, in FIG. 2C, after receiving the second scan request SCAN_RQ2, the controller 130 may perform the remaining operation of the second selection operation RY2 of sequentially checking whether each of two data units KPDATA7 and KPDATA8 corresponding to subsequent orders in the prediction information PRE_ORDER, among the kept data units KPDATA5, KPDATA6, KPDATA7, and KPDATA8 classified as second group GP2, has been updated, and of storing an updated data unit in the update cache UPC. That is, from FIG. 2C, it may be seen that the controller 130 completes the execution of the second selection operation RY2 with reference to the prediction information PRE_ORDER in a state in which the second scan request SCAN_RQ2 has been received.

From FIGS. 2B and 2C, it may be seen that the controller 130 checks that a sixth kept data unit KPDATA6, among the kept data units KPDATA5, KPDATA6, KPDATA7, and KPDATA8 classified as second group GP2, has been updated through the second selection operation RY2, and the controller 130 stores, (KPDATA6{UPDATE}), the sixth kept data unit KPDATA6 in the update cache UPC.

The controller 130 may permit the access request NM_CMD from the host 102 in the interval in which the second selection operation RY2 is performed because the migration operation in FIGS. 2B and 2C is an operation in a live-time mode, LIVE-TIME#1 or LIVE-TIME#2.

After completing a scan operation including the first selection operation RY1 and the second selection operation RY2, the controller 130 may manage the data units KPDATA1{UPDATED} and KPDATA6{UPDATED} stored in the update cache UPC as the transmission data unit TRDATA1 by merging the data units KPDATA1{UPDATED} and KPDATA6{UPDATED} by a predetermined number.

The controller 130 may perform a copy operation COPY_OP of copying the transmission data unit TRDATA1 that has been stored in the update cache UPC to the external storage device 104 based on a request COPY_RQ from the host 102. From FIG. 2C, it may be seen that some data units KPDATA1{UPDATED} and KPDATA6{UPDATED}, from among the data units KPDATA1, KPDATA2, KPDATA3, KPDATA4, KPDATA5, KPDATA6, KPDATA7, and KPDATA8 that have been stored in the external storage device 104, are updated through the copy operation COPY_OP.

When the number of data units that have been stored in the update cache UPC is less than a critical number in the first update processing loop described with reference to FIGS. 2A to 2C, the controller 130 may terminate the live-time mode, LIVE-TIME#1 or LIVE-TIME#2, and start the down-time mode.

However, when the number of data units that have been stored in the update cache UPC is equal to or greater than the critical number in the first update processing loop described with reference to FIGS. 2A to 2C, in the live-time mode LIVE-TIME#1, the controller 130 may perform a second update processing loop by sequentially referring to FIGS. 2D, 2E, 2B, and 2C. In a live-time mode LIVE-TIME#2, the controller 130 may perform the second update processing loop by sequentially referring to FIGS. 2F, 2B, and 2C.

FIG. 2D illustrates a live-time mode LIVE-TIME#1, in which the controller 130 may perform some of the second selection operation RY2 of sequentially checking whether each of two data units KPDATA1 and KPDATA2 corresponding to previous orders in the prediction information PRE_ORDER, among the kept data units KPDATA1, KPDATA2, KPDATA3, and KPDATA4 classified as the first group GP1, has been updated, and storing an updated data unit in the update cache UPC in the state in which the second scan request SCAN_RQ2 has not been received. That is, from FIG. 2D, it may be seen that the controller 130 starts the execution of the second selection operation RY2 with reference to the prediction information PRE_ORDER in the state in which the second scan request SCAN_RQ2 has not been received.

In FIG. 2E, the controller 130 continues to perform the second selection operation RY2 that has already been started in FIG. 2D even after the second scan request SCAN_RQ2 is applied. That is, in FIG. 2E, the controller 130 may perform the remaining operation of the second selection operation RY2 of sequentially checking whether each of two data units KPDATA3 and KPDATA4 corresponding to subsequent orders in the prediction information PRE_ORDER, among the kept data units KPDATA1, KPDATA2, KPDATA3, and KPDATA4 classified as first group GP1, has been updated, and storing an updated data unit in the update cache UPC after the second scan request SCAN_RQ2 is received. That is, from FIG. 2E, it may be seen that the controller 130 completes the execution of the second selection operation RY2 with reference to the prediction information PRE_ORDER in a state in which the second scan request SCAN_RQ2 has been received.

From FIGS. 2D and 2E, it may be seen that the controller 130 checks that the first kept data unit KPDATA1, among the kept data units KPDATA1, KPDATA2, KPDATA3, and KPDATA4 classified as the first group GP1, has been updated and stores (KPDATA1{UPDATE}) the first kept data unit KPDATA1 in the update cache UPC through the second selection operationRY2.

Referring back to FIG. 2B, the controller 130 starts the execution of the second selection operation RY2 with reference to the prediction information PRE_ORDER in a state in which the second scan request SCAN_RQ2 has not been received.

Referring back to FIG. 2C, the controller 130 completes the execution of the second selection operation RY2 with reference to the prediction information PRE_ORDER in a state in which the second scan request SCAN_RQ2 has been received. For the detailed operations of FIGS. 2B and 2C, reference may be made to the aforementioned descriptions.

The controller 130 may permit the access request NM_CMD from the host 102 in the interval in which the second selection operation RY2 is continuously performed twice because the migration operation, which has been disclosed in FIGS. 2D, 2E, 2B, and 2C, is an operation in the live-time mode LIVE-TIME#1.

The controller 130 may manage the data units KPDATA1{UPDATED} and KPDATA6{UPDATED} that have been stored in the update cache UPC as the transmission data unit TRDATA1, by merging the data units KPDATA1{UPDATED} and KPDATA6{UPDATED} by a predetermined number after a scan operation including the second selection operation RY2, which has been continuously performed twice, is completed.

The controller 130 may perform the copy operation COPY_OP of copying the transmission data unit TRDATA1 that has been stored in the update cache UPC to the external storage device 104 based on the request COPY_RQ from the host 102.

When the number of data units that have been stored in the update cache UPC is less than a critical number in the second update processing loop described with reference to FIGS. 2D, 2E, 2B, and 2C, the controller 130 may terminate the live-time mode LIVE-TIME#1 of the migration operation, and may start the down-time mode.

However, when the number of data units that have been stored in the update cache UPC is equal to or greater than the critical number in the second update processing loop described with reference to FIGS. 2D, 2E, 2B, and 2C, the controller 130 may perform a third update processing loop in the live-time mode LIVE-TIME#1 by sequentially referring to FIGS. 2D, 2E, 2B, and 2C once more.

FIG. 2F describes the live-time mode LIVE-TIME#2, in which the controller 130 may perform the first selection operation RY1 of sequentially checking whether each of the kept data units KPDATA1, KPDATA2, KPDATA3, and KPDATA4 classified as the first group GP1 has been updated according to an update check order included in the first scan request SCAN_RQ1, and storing an updated data unit in the update cache UPC based on the first scan request SCAN_RQ1 received from the host 102. From FIG. 2F, it may be seen that the controller 130 checks that the first kept data unit KPDATA1, among the kept data units KPDATA1, KPDATA2, KPDATA3, and KPDATA4 classified as first group GP1, has been updated through the first selection operation RY1 and stores (KPDATA1{UPDATE}), the first kept data unit KPDATA1, in the update cache UPC.

During the execution of the first selection operation RY1 or after the execution of the first selection operation RY1 is completed, the controller 130 may determine the prediction information PRE_ORDER by analyzing an update check order included in the first scan request SCAN_RQ1, and may store the prediction information PRE_ORDER that has been determined in the internal memory 144 of the controller 130. In this case, the controller 130 may delete the prediction information PRE_ORDER that has already been stored in the internal memory 144 of the controller 130, and may store the prediction information PRE_ORDER that has been newly determined. That is, the controller 130 may delete the prediction information PRE_ORDER that has been determined in the first selection operation RY1 of the first update processing loop and stored in the internal memory 144 of the controller 130, which has described with reference to FIG. 2A. Instead, the controller 130 may store the prediction information PRE_ORDER that has been determined in the first selection operation RY1 of the second update processing loop, which has been described with reference to FIG. 2F.

Referring back to FIG. 2B, it may be seen that the controller 130 starts the execution of the second selection operation RY2 with reference to the prediction information PRE_ORDER in a state in which the second scan request SCAN_RQ2 has not been received.

Referring back to FIG. 2C, it may be seen that the controller 130 completes the execution of the second selection operation RY2 with reference to the prediction information PRE_ORDER in a state in which the second scan request SCAN_RQ2 has been received. For the detailed operations of FIGS. 2B and 2C, reference may be made to the aforementioned descriptions.

The controller 130 may permit the access request NM_CMD from the host 102 in the interval in which the first selection operation RY1 and the second selection operation RY2 are sequentially performed because the migration operation, which has been disclosed in FIGS. 2F, 2B, and 2C, is an operation in the live-time mode LIVE-TIME#2.

After completing a scan operation including the first selection operation RY1 and the second selection operation RY2, the controller 130 may manage the data units KPDATA1{UPDATED} and KPDATA6{UPDATED} that have been stored in the update cache UPC as the transmission data unit TRDATA1 by merging the data units KPDATA1{UPDATED} and KPDATA6{UPDATED} by a predetermined number.

The controller 130 may perform the copy operation COPY_OP of copying the transmission data unit TRDATA1 that has been stored in the update cache UPC to the external storage device 104 based on the request COPY_RQ from the host 102.

When the number of data units that have been stored in the update cache UPC is less than a critical number in the second update processing loop described with reference to FIGS. 2F, 2B, and 2C, the controller 130 may terminate the live-time mode LIVE-TIME#2 of the migration operation, and may start the down-time mode.

However, when the number of data units that have been stored in the update cache UPC is equal to or greater than the critical number in the second update processing loop described with reference to FIGS. 2F, 2B, and 2C, the controller 130 may perform a third update processing loop in the live-time mode LIVE-TIME#2 by sequentially referring to FIGS. 2F, 2B, and 2C once more.

FIGS. 3A to 3E are diagrams describing another example of a live migration operation that is performed in a storage device according to an embodiment of the present disclosure disclosed in FIG. 1.

FIGS. 3A, 3B, 3D, and 3E in sequence refer to an example of an operation of setting, as a second selection operation RY2, all selection operations in one update processing loop in the down-time mode DOWN-TIME#1 of a migration operation, which is entered after the exiting of the live-time mode LIVE-TIME#1 of the migration operation.

Furthermore, FIGS. 3C to 3E refer sequentially to an example of an operation of setting, as the first selection operation RY1, only one selection operation in one update processing loop included in the down-time mode DOWN-TIME#2 of the migration operation, which is entered after the leaving the live-time mode LIVE-TIME#2 of the migration operation, and setting all of the remaining selection operation as the second selection operation RY2.

Specifically, referring to FIG. 3A, the controller 130 may perform some of the second selection operation RY2 of sequentially checking whether each of two data units KPDATA1 and KPDATA2 corresponding to previous orders in the prediction information PRE_ORDER, from among the kept data units KPDATA1, KPDATA2, KPDATA3, and KPDATA4 classified as first group GP1, has been updated and storing an updated data unit in the update cache UPC in the state in which the second scan request SCAN_RQ2 has not been received. That is, from FIG. 3A, it may be seen that the controller 130 starts the execution of the second selection operation RY2 with reference to the prediction information PRE_ORDER in a state in which the second scan request SCAN_RQ2 has not been received.

In FIG. 3B, the controller 130 continues to perform the second selection operation RY2 that has already been started in FIG. 3A even after the second scan request SCAN_RQ2 is received. That is, in FIG. 3B, after receiving the second scan request SCAN_RQ2, the controller 130 may perform the remaining operation of the second selection operation RY2 of sequentially checking whether each of two data units KPDATA3 and KPDATA4 corresponding to subsequent orders in the prediction information PRE_ORDER, among the kept data units KPDATA1, KPDATA2, KPDATA3, and KPDATA4 classified as first group GP1, has been updated and storing an updated data unit in the update cache UPC. That is, in FIG. 3B, the controller 130 completes the execution of the second selection operation RY2 with reference to the prediction information PRE_ORDER in a state in which the second scan request SCAN_RQ2 has been received.

In FIGS. 3A and 3B, the controller 130 checks that the fourth kept data unit KPDATA4, among the kept data units KPDATA1, KPDATA2, KPDATA3, and KPDATA4 classified as first group GP1, has been updated through the second selection operation RY2 and stores (KPDATA4{UPDATE}) the fourth kept data unit KPDATA4 in the update cache UPC.

Referring to FIG. 3D, the controller 130 may perform some of the second selection operation RY2 of sequentially checking whether each of two data units KPDATA5 and KPDATA6 corresponding to previous orders in the prediction information PRE_ORDER, among the kept data units KPDATA5, KPDATA6, KPDATA7, and KPDATA8 classified as second group GP2, has been updated and storing an updated data unit in the update cache UPC in a state in which the second scan request SCAN_RQ2 has not been received. That is, in FIG. 3D, the controller 130 starts the execution of the second selection operation RY2 with reference to the prediction information PRE_ORDER in a state in which the second scan request SCAN_RQ2 has not been received.

Referring to FIG. 3E, the controller 130 continues to perform the second selection operation RY2 that has already been started in FIG. 3D even after the second scan request SCAN_RQ2 is received. That is, in FIG. 3E, the controller 130 may perform the remaining operation of the second selection operation RY2 of sequentially checking whether each of two data units KPDATA7 and KPDATA8 corresponding to subsequent orders in the prediction information PRE_ORDER, among the kept data units KPDATA5, KPDATA6, KPDATA7, and KPDATA8 classified as the second group GP2, has been updated and storing an updated data unit in the update cache UPC after the second scan request SCAN_RQ2 is received. That is, from FIG. 3E, the controller 130 completes the execution of the second selection operation RY2 with reference to the prediction information PRE_ORDER in a state in which the second scan request SCAN_RQ2 has been received.

In FIGS. 3D and 3E, the controller 130 checks that the sixth kept data unit KPDATA6, among the kept data units KPDATA5, KPDATA6, KPDATA7, and KPDATA8 classified as second group GP2, has been updated through the second selection operation RY2 and stores (KPDATA6{UPDATE}) the sixth kept data unit KPDATA6 in the update cache UPC.

The controller 130 may prohibit the update of the kept data units KPDATA1, KPDATA2, KPDATA3, KPDATA4, KPDATA5, KPDATA6, KPDATA7, and KPDATA8 in the interval in which the second selection operation RY2 is continuously performed twice because the migration operation disclosed in FIGS. 3A, 3B, 3D, and 3E is an operation in the down-time mode DOWN-TIME#1.

Furthermore, the controller 130 may manage the data units KPDATA4{UPDATED} and KPDATA6{UPDATED} that have been stored in the update cache UPC as the transmission data unit TRDATA1 by merging the data units KPDATA4{UPDATED} and KPDATA6{UPDATED} by a predetermined number after a scan operation including the second selection operation RY2, which is continuously performed twice, is completed.

The controller 130 may perform the copy operation COPY_OP of copying the transmission data unit TRDATA1 that has been stored in the update cache UPC to the external storage device 104 based on the request COPY_RQ from the host 102. From FIG. 3E, it may be seen that some data units KPDATA4{UPDATED} and KPDATA6{UPDATED}, among the data units KPDATA1, KPDATA2, KPDATA3, KPDATA4, KPDATA5, KPDATA6, KPDATA7, and KPDATA8 that have been stored in the external storage device 104, have been updated through the copy operation COPY_OP.

The controller 130 may complete the migration operation, after performing the copy operation COPY_OP of copying the transmission data unit TRDATA1 that has been stored in the update cache UPC to the external storage device 104.

Referring to FIG. 3C, in the down-time mode DOWN-TIME#2 of the migration operation, the controller 130 may perform the first selection operation RY1 of sequentially checking whether each of the kept data units KPDATA1, KPDATA2, KPDATA3, and KPDATA4 classified as first group GP1 has been updated according to an update check order included in the first scan request SCAN_RQ1, and storing an updated data unit in the update cache UPC based on the first scan request SCAN_RQ1 from the host 102. In FIG. 3C, the controller 130 checks that the fourth kept data unit KPDATA4, among the kept data units KPDATA1, KPDATA2, KPDATA3, and KPDATA4 classified as first group GP1, has been updated through the first selection operation RY1 and stores (KPDATA4{UPDATE}) the fourth kept data unit KPDATA4 in the update cache UPC.

During the execution of the first selection operation RY1 or after the execution of the first selection operation RY1 is completed, the controller 130 may determine the prediction information PRE_ORDER by analyzing an update check order included in the first scan request SCAN_RQ1, and may store the prediction information PRE_ORDER that has been determined in the internal memory 144 of the controller 130.

In this case, the controller 130 may delete the prediction information PRE_ORDER that has already been stored in the internal memory 144 of the controller 130, and may store the prediction information PRE_ORDER that has been newly determined. That is, the controller 130 may delete the prediction information PRE_ORDER that has been determined in the live-time mode LIVE-TIME#2 of the migration operation and that has been stored in the internal memory 144 of the controller 130, and may store the new prediction information PRE_ORDER that has been determined in the down-time mode DOWN-TIME#2 of the migration operation in the internal memory 144 of the controller 130.

Referring to FIG. 3D, the controller 130 may perform some of the second selection operation RY2 of sequentially checking whether each of two data units KPDATA5 and KPDATA6 corresponding to previous orders in the prediction information PRE_ORDER, among the kept data units KPDATA5, KPDATA6, KPDATA7, and KPDATA8 classified as second group GP2, and storing an updated data unit in the update cache UPC in the state in which the second scan request SCAN_RQ2 has not been received. That is, from FIG. 3D, it may be seen that the controller 130 starts the execution of the second selection operation RY2 with reference to the prediction information PRE_ORDER in a state in which the second scan request SCAN_RQ2 has not been received.

Referring to FIG. 3E, the controller 130 continues to perform the second selection operation RY2 that has already been started in FIG. 3D even after the second scan request SCAN_RQ2 is received. That is, in FIG. 3E, after receiving the second scan request SCAN_RQ2, the controller 130 may perform the remaining operation of the second selection operation RY2 of sequentially checking whether each of two data units KPDATA7 and KPDATA8 corresponding to subsequent orders in the prediction information PRE_ORDER, among the kept data units KPDATA5, KPDATA6, KPDATA7, and KPDATA8 classified as the second group GP2, has been updated and storing an updated data unit in the update cache UPC. That is, from FIG. 3E, the controller 130 completes the execution of the second selection operation RY2 with reference to the prediction information PRE_ORDER in a state in which the second scan request SCAN_RQ2 has been received.

In FIGS. 3D and 3E, the controller 130 checks that the sixth kept data unit KPDATA6, among the kept data units KPDATA5, KPDATA6, KPDATA7, and KPDATA8 classified as second group GP2, has been updated through the second selection operation RY2 and stores (KPDATA6{UPDATE}) the sixth kept data unit KPDATA6 in the update cache UPC.

The controller 130 may prohibit the update of the kept data units KPDATA1, KPDATA2, KPDATA3, KPDATA4, KPDATA5, KPDATA6, KPDATA7, and KPDATA8 in the interval in which the first selection operation RY1 and the second selection operation RY2 are performed because the migration operation disclosed in FIGS. 3C to 3E is an operation in the down-time mode DOWN-TIME#2.

After completing a scan operation including the first selection operation RY1 and the second selection operation RY2, the controller 130 may manage the data units KPDATA4{UPDATED} and KPDATA6{UPDATED} that have been stored in the update cache UPC as the transmission data unit TRDATA1 by merging the data units KPDATA4{UPDATED} and KPDATA6{UPDATED} by a predetermined number.

The controller 130 may perform the copy operation COPY_OP of copying the transmission data unit TRDATA1 that has been stored in the update cache UPC to the external storage device 104 based on the request COPY_RQ from the host 102. In FIG. 3E, it may be seen that some data units KPDATA4{UPDATED} and KPDATA6{UPDATED}, among the data units KPDATA1, KPDATA2, KPDATA3, KPDATA4, KPDATA5, KPDATA6, KPDATA7, and KPDATA8 that have been stored in the external storage device 104, have been updated through the copy operation COPY_OP.

After performing the copy operation COPY_OP of copying the transmission data unit TRDATA1 that has been stored in the update cache UPC to the external storage device 104, the controller 130 may complete the migration operation.

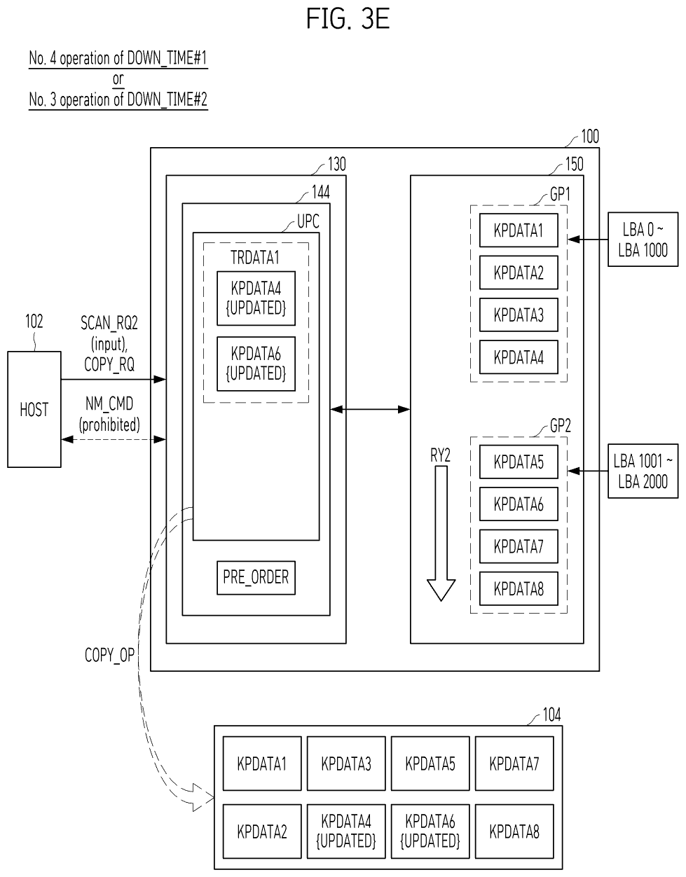

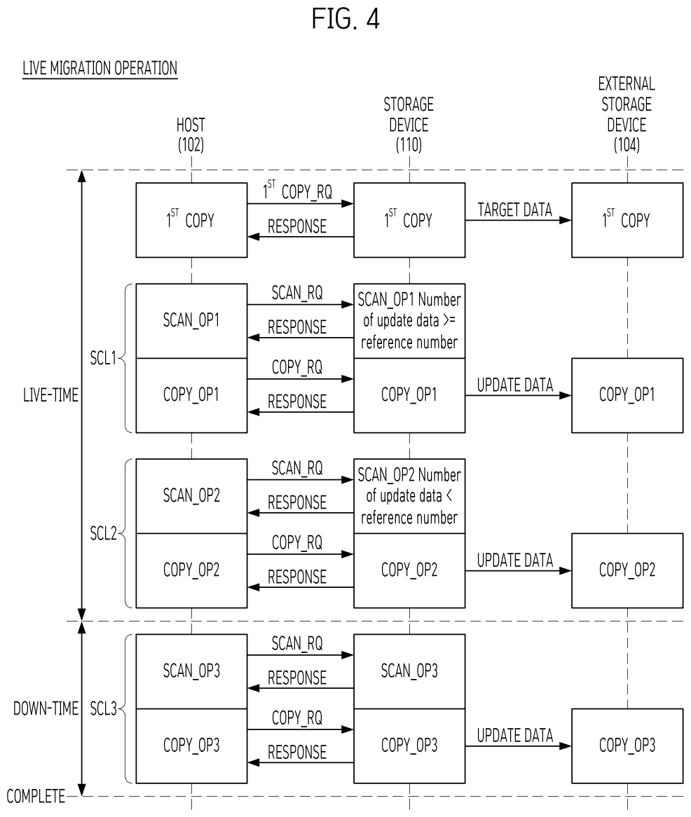

FIG. 4 is a diagram describing the order of a live migration operation that is performed in a storage device according to an embodiment of the present disclosure.

Referring to FIG. 4, a live migration operation (LIVE MIGRATION OPERATION) may be started based on a request 1^{ST} COPY_RQ for a first copy operation 1^{ST} COPY from a host 102 to a storage device 110 after entering a live-time mode LIVE-TIME.

Based on the request 1^{ST} COPY_RQ from the host 102, the first copy operation 1^{ST} COPY of copying a data unit TARGET DATA that has been selected for a migration operation, among all data units that have been stored in a memory device 150 within the storage device 110, to the external storage device 104 may be performed.

The storage device 110 may respond (RESPONSE) to the host 102 with respect to the completion of the execution of the first copy operation 1^{ST} COPY.

The storage device 110 may permit an access operation from the host 102 for the data unit that has been stored in the memory device 150 within the storage device 110, during the interval in which the first copy operation 1^{ST} COPY is executed because the interval in which the first copy operation 1^{ST} COPY is executed is included in the interval when the live-time mode LIVE-TIME is entered. That is, the host 102 may perform the access operation on the storage device 110 in the interval in which the first copy operation 1^{ST} COPY is executed.

The host 102 may perform a first update processing loop SCL1 when receiving, from the storage device 110, the response RESPONSE that provides notification that the execution of the first copy operation 1^{ST} COPY has been completed.

The storage device 110 may perform a scan operation SCAN_OP1 included in the first update processing loop SCL1 based on a request SCAN_RQ from the host 102.

The storage device 110 may transmit, to the host 102, a response RESPONSE indicating that the number of update data is a reference number or more as the results of the execution of the scan operation SCAN_OP1 included in the first update processing loop SCL1.

The host 102 may prepare a second update processing loop SCL2 based on the response for the scan operation SCAN_OP1 included in the first update processing loop SCL1, which has been received from the storage device 110. The host 102 may request (COPY_RQ) a copy operation COPY_OP1 included in the first update processing loop SCL1 from the storage device 110 separately from an operation of preparing the second update processing loop SCL2. The storage device 110 may perform the copy operation COPY_OP1 included in the first update processing loop SCL1 based on the request COPY_RQ from the host 102. That is, the storage device 110 may copy update data UPDATE DATA that have been checked in the scan operation SCAN_OP1 included in the first update processing loop SCL1 to the external storage device 104 through the copy operation COPY_OP1 included in the first update processing loop SCL1.

The storage device 110 may permit an access operation from the host 102 for a data unit that has been stored in the memory device 150 within the storage device 110, during the interval in which the first update processing loop SCL1 is executed because the interval in which the first update processing loop SCL1 is executed is included in the interval during which the live-time mode LIVE-TIME is entered. That is, the host 102 may perform the access operation on the storage device 110 in the interval in which the first update processing loop SCL1 is executed.

Thereafter, the storage device 110 may perform a scan operation SCAN_OP2 included in the second update processing loop SCL2 based on a request SCAN_RQ from the host 102.

The storage device 110 may transmit, to the host 102, a response RESPONSE indicating that the number of update data is less than the reference number as the results of the execution of the scan operation SCAN_OP2 included in the second update processing loop SCL2.

The host 102 may prepare to enter the down-time mode DOWN-

TIME based on the response for the scan operation SCAN_OP2 included in the second update processing loop SCL2, which has been received from the storage device 110. The host 102 may request (COPY_RQ) a copy operation COPY_OP2 included in the second update processing loop SCL2 from the storage device 110 separately from an operation of preparing to enter the down-time mode DOWN-TIME. The storage device 110 may perform the copy operation COPY_OP2 included in the second update processing loop SCL2 based on the request COPY_RQ from the host 102. That is, the storage device 110 may copy update data UPDATE DATA that have been checked in the scan operation SCAN_OP2 included in the second update processing loop SCL2 to the external storage device 104 through the copy operation COPY_OP2 included in the second update processing loop SCL2.

The storage device 110 may permit an access operation from the host 102 for a data unit that has been stored in the memory device 150 within the storage device 110, during the interval in which the second update processing loop SCL2 is executed because the interval in which the second update processing loop SCL2 is executed is within the interval in which the live-time mode LIVE-TIME is entered. That is, the host 102 may perform the access operation on the storage device 110 in the interval in which the second update processing loop SCL2 is executed.

Thereafter, the host 102 may enter the down-time mode DOWN-TIME based on a response RESPONSE of the scan operation SCAN_OP2 included in the second update processing loop SCL2, which has been received from the storage device 110, that is, a response RESPONSE indicating that the number of update data that have been checked in the scan operation SCAN_OP2 included in the second update processing loop SCL2 is less than the reference number.

After entering the down-time mode DOWN-TIME, the storage device 110 may perform a scan operation SCAN_OP3 included in a third update processing loop SCL3 based on the request SCAN_RQ from the host 102.

The storage device 110 may transmit, to the host 102, a response RESPONSE indicating that the execution of the scan operation SCAN_OP3 included in the third update processing loop SCL3 has been completed. At this time, the storage device 110 might not respond to the host 102 with respect to how many update data have been checked in the process of executing the scan operation SCAN_OP3 included in the third update processing loop SCL3 because the scan operation SCAN_OP3 included in the third update processing loop SCL3 is an operation that has been performed in the down-time mode DOWN-TIME.

The host 102 may request (COPY_RQ) a copy operation COPY_OP3 included in the third update processing loop SCL3 from the storage device 110 based on the response of the scan operation SCAN_OP3 included in the third update processing loop SCL3, which has been received from the storage device 110. The storage device 110 may perform the copy operation COPY_OP3 included in the third update processing loop SCL3 based on the request COPY_RQ from the host 102. That is, the storage device 110 may copy update data UPDATE DATA that have been checked in the scan operation SCAN_OP3 included in the third update processing loop SCL3 to the external storage device 104 through the copy operation COPY_OP3 included in the third update processing loop SCL3.

The storage device 110 may prohibit the update of a data unit that has been stored in the memory device 150 within the storage device 110 during the interval in which the third update processing loop SCL3 is executed because the interval in which the third update processing loop SCL3 is executed is within in the interval in which the down-time mode DOWN-TIME is entered.

The storage device 110 may transmit, to the host 102, a response RESPONSE indicating that the execution of the copy operation COPY_OP3 included in the third update processing loop SCL3 has been completed. The host 102 may complete (COMPLETE) the migration operation based on the response of the copy operation COPY_OP3 included in the third update processing loop SCL3, which has been received from the storage device 110.

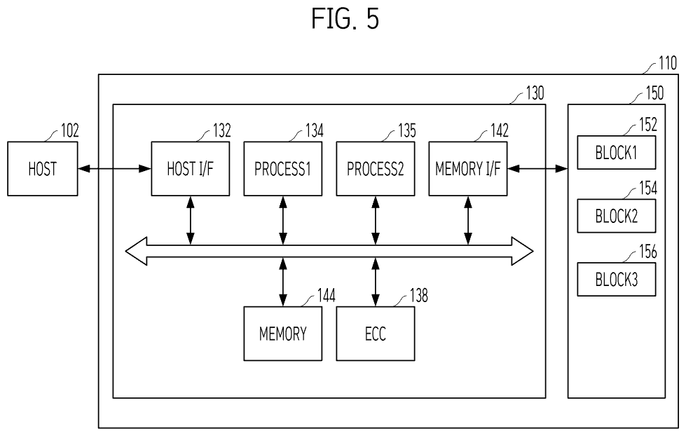

FIG. 5 is a diagram describing a schematic construction of a storage device according to an embodiment of the present disclosure.

Referring to FIG. 5, a data processing system may include a host 102 engaged or coupled with a memory system, such as a storage device 110. For example, the host 102 and the storage device 110 can be coupled to each other via a data bus, a host cable and the like to perform data communication.

The storage device 110 may include a memory device 150 and a controller 130. The memory device 150 and the controller 130 in the storage device 110 may be considered components or elements physically separated from each other. The memory device 150 and the controller 130 may be connected via at least one data path. For example, the data path may include a channel and/or a way.

According to an embodiment, the memory device 150 and the controller 130 may be components or elements that are functionally divided. Further, according to an embodiment, the memory device 150 and the controller 130 may be implemented with a single chip or a plurality of chips. The controller 130 may perform a data input/output operation in response to a request input from the external device. For example, when the controller 130 performs a read operation in response to a read request input from an external device, data stored in a plurality of non-volatile memory cells included in the memory device 150 is transferred to the controller 130.

The controller 130 may control the memory device 150 to perform read, program and erase operations corresponding to commands inputted from the host 102, and the storage device 110 may independently perform the operations regardless of commands inputted from an external device such as the host 102.

In an embodiment, the controller 130 may autonomously generate a command, an address, and data regardless of a request from the host 102, and may transmit the command, the address, and the data to the memory device 150. For example, the controller 130 may provide commands, addresses, and data to the memory device 150 so as to perform background operations, such as a read operation and a program operation for wear leveling, garbage collection, and read reclaim.

The memory device 150 may include a plurality of memory blocks 152, 154, 156. Each memory block 152, 154, 156 may include a plurality of memory cells. One memory block may include a plurality of pages. In an embodiment, each page may be a unit by which data is stored in the memory device 150 or by which data stored in the memory device 150 is read. A memory block may be a unit by which data is erased.

The memory cells included in the memory device 150 may be configured as single level cells (SLCs) each storing 1-bit data, multi-level cells (MLCs) each storing 2-bit data, triple level cells (TLCs) each storing 3-bit data or quad level cells (QLCs) each storing 4-bit data.

The memory device 150 may receive a command and an address from the controller 130, and may access the area of the memory cell array, selected by the address. That is, the memory device 150 may perform an operation indicated by the command on the area selected by the address. For example, the memory device 150 may perform a write operation (i.e., program operation), a read operation, and an erase operation. During a program operation, the memory device 150 may program data to the area selected by the address. During a read operation, the memory device 150 may read data from the area selected by the address. During an erase operation, the memory device 150 may erase data stored in the area selected by the address.

In an embodiment, the memory device 150 is embodied as a non-volatile memory such as a flash memory, for example, as a NAND flash memory, a NOR flash memory, or the like. In another embodiment, the memory device 150 may be implemented by at least one of a read only memory (ROM), a mask read only memory (MROM), a programmable read only memory (PROM), an erasable read only memory (EPROM), an electrically erasable read only memory (EEPROM), a ferromagnetic read only memory (FROM), a resistive random access memory (RRAM), a phase change random access memory (PCRAM), a ferroelectrics random access memory (FRAM), a spin transfer torque random access memory (STT-RAM), and a spin transfer torque magnetic random access memory (STT-MRAM), or the like.

Examples of the data processing system 100 including the host 102 interworking with the storage device 110 or the storage device 110 may include a mobility electronic device such as an automotive, a portable electronic device such as a mobile phone, an MP3 player and a laptop computer and a non-portable electronic device such as a desktop computer, a game machine, a TV and a projector. The host 102 may provide interaction between the host 102 and a user using the data processing system 100 or the storage device 110 through at least one operating system (OS). The host 102 may transmit a plurality of commands corresponding to requests of the user to the storage device 110, and the storage device 110 may perform operations corresponding to the plurality of commands, i.e., operations corresponding to the requests of the user.

For example, the storage device 110 may be implemented with any of various types of storage devices, which may be electrically coupled with the host 102, according to a protocol of a host interface. Non-limiting examples of suitable storage devices include a solid state drive (SSD), a multimedia card (MMC), an embedded MMC (eMMC), a reduced size MMC (RS-MMC), a micro-MMC, a secure digital (SD) card, a mini-SD, a micro-SD, a universal serial bus (USB) storage device, a universal flash storage (UFS) device, a compact flash (CF) card, a smart media (SM) card, a memory stick, and the like.

According to an embodiment, the controller 130 may include a host interface 132, a first processor 134, a second processor 135, the error correction circuitry (ECC) 138, a memory interface 142, and a memory 144. Components included in the controller 130 as illustrated in FIG. 5 may vary according to structures, functions, operation performance, or the like, regarding the storage device 110.

The host 102 and the storage device 110 each may include a controller or an interface for transmitting and receiving signals, data, and the like, in accordance with one or more predetermined protocols. For example, the host interface 132 in the storage device 110 may include an apparatus capable of transmitting signals, data, and the like to the host 102 or receiving signals, data, and the like from the host 102.

The host interface 132 included in the controller 130 may receive signals, commands (or requests), and/or data input from the host 102 via a bus. For example, the host 102 and the storage device 110 may use a predetermined set of rules or procedures for data communication or a preset interface to transmit and receive data therebetween.

Examples of communication standards or interfaces used to transmit/receive data may include various form factors such as 2.5-inch form factor, 1.8-inch form factor, MO-297, MO-300, M.2, and EDSFF (Enterprise and Data Center SSD Form Factor) and various communication standards or interfaces such as USB (Universal Serial Bus), MMC (Multi-Media Card), PATA (Parallel Advanced Technology Attachment), SCSI (Small Computer System Interface), ESDI (Enhanced Small Disk Interface), IDE (Integrated Drive Electronics), PCIe (Peripheral Component Interconnect Express), SAS (Serial-attached SCSI), SATA (Serial Advanced Technology Attachment), and MIPI (Mobile Industry Processor Interface).

According to an embodiment, the host interface 132 is a type of layer for exchanging data with the host 102 and is implemented with, or driven by, firmware called a host interface layer (HIL). According to an embodiment, the host interface 132 can include a command queue.

The Integrated Drive Electronics (IDE) or Advanced Technology Attachment (ATA) may be used as one of the interfaces for transmitting and receiving data and, for example, may use a cable including 40 wires connected in parallel to support data transmission and data reception between the host 102 and the storage device 110. When a plurality of memory systems 110 are connected to a single host 102, the plurality of memory systems 110 may be divided into a master and a slave by using a position or a dip switch to which the plurality of memory systems 110 are connected. The storage device 110 set as the master may be used as a main memory device. The IDE (ATA) may include, for example, Fast-ATA, ATAPI, or Enhanced IDE (EIDE).

A Serial Advanced Technology Attachment (SATA) interface is a type of serial data communication interface that is compatible with various ATA standards of parallel data communication interfaces which are used by Integrated Drive Electronics (IDE) devices. The 40 wires in the IDE interface can be reduced to six wires in the SATA interface. For example, 40 parallel signals for the IDE can be converted into 6 serial signals for the SATA interface. The SATA interface has been widely used because of its faster data transmission and reception rate and its less resource consumption in the host 102 used for the data transmission and reception. The SATA interface may connect up to 30 external devices to a single transceiver included in the host 102. In addition, the

SATA interface can support hot plugging that allows an external device to be attached to or detached from the host 102, even while data communication between the host 102 and another device is being executed. Thus, the storage device 110 can be connected or disconnected as an additional device, like a device supported by a universal serial bus (USB) even when the host 102 is powered on. For example, in the host 102 having an eSATA port, the storage device 110 may be freely attached to or detached from the host 102 like an external hard disk.

Small Computer System Interface (SCSI) is a type of serial data communication interface used for connecting a computer or a server with other peripheral devices. The SCSI can provide a high transmission speed, as compared with other interfaces such as IDE and SATA. In the SCSI, the host 102 and at least one peripheral device (e.g., storage device 110) are connected in series, but data transmission and reception between the host 102 and each peripheral device may be performed through a parallel data communication. In the SCSI, it is easy to connect or disconnect a device such as the storage device 110 to or from the host 102. The SCSI can support connections of 15 other devices to a single transceiver included in host 102.

Serial Attached SCSI (SAS) can be understood as a serial data communication version of the SCSI. In the SAS, the host 102 and a plurality of peripheral devices are connected in series, and data transmission and reception between the host 102 and each peripheral device may be performed in a serial data communication scheme. The SAS can support connection between the host 102 and the peripheral device through a serial cable instead of a parallel cable, to easily manage equipment using the SAS and enhance or improve operational reliability and communication performance. The SAS may support connections of eight external devices to a single transceiver included in the host 102.

The Non-volatile memory express (NVMe) is a type of interface based at least on a Peripheral Component Interconnect Express (PCIe) designed to increase performance and design flexibility of the host 102, servers, computing devices, and the like equipped with the non-volatile storage device 110. The PCIe can use a slot or a specific cable for connecting a computing device (e.g., host 102) and a peripheral device (e.g., storage device 110). For example, the PCIe can use a plurality of pins (e.g., 18 pins, 32 pins, 49 pins, or 82 pins) and at least one wire (e.g., x1, x4, x8, or x16) to achieve high speed data communication over several hundred MB per second (e.g., 250 MB/s, 500 MB/s, 984.6250 MB/s, or 1969 MB/s). According to an embodiment, the PCIe scheme may achieve bandwidths of tens to hundreds of Giga bits per second. The NVMe can support an operation speed of the non-volatile storage device 110, such as an SSD, that is faster than a hard disk.

According to an embodiment, the host 102 and the storage device 110 may be connected through a universal serial bus (USB). The Universal Serial Bus (USB) is a type of scalable, hot-pluggable plug-and-play serial interface that can provide cost-effective standard connectivity between the host 102 and peripheral devices such as a keyboard, a mouse, a joystick, a printer, a scanner, a storage device, a modem, a video camera, and the like. A plurality of peripheral devices such as the storage device 110 may be coupled to a single transceiver included in the host 102.

The error correction unit 138 may check and correct errors in data transmitted between the controller 130 and the memory device 150. The error correction unit 138 may be implemented as a separate module, circuit or firmware in the controller 130, but also be implemented in the memory device 150 according to an embodiment.

The error correction circuitry 138 may include all circuits, modules, systems, and/or devices for performing the error correction operation based on at least one of the above-described codes.

The error correction circuitry 138 can correct error bits of data read from the memory device 150, and may include an error correction code (ECC) encoder and an ECC decoder. The ECC encoder may perform error correction encoding of data to be programmed in the memory device 150 to generate encoded data into which a parity bit is added, and store the encoded data in the memory device 150. The ECC decoder can detect and correct error bits contained in the data read from the memory device 150 when the controller 130 reads the data stored in the memory device 150. For example, after performing error correction decoding on the data read from the memory device 150, the error correction circuitry 138 determines whether the error correction decoding has succeeded or not, and outputs an instruction signal, e.g., a correction success signal or a correction fail signal, based on a result of the error correction decoding. The error correction circuitry 138 may use a parity bit, which has been generated during the ECC encoding process for the data stored in the memory device 150, in order to correct the error bits of the read data entries. When the number of the error bits is greater than or equal to the number of correctable error bits, the error correction circuitry 138 may not correct the error bits and instead may output the correction fail signal indicating failure in correcting the error bits.

According to an embodiment, the error correction circuitry 138 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM),or the like.

An operation performed by the ECC decoder, that is, an operation of detecting and correcting errors included in read data, may be an operation distinct from the above-described read retry operation. According to an embodiment, the controller 130 may perform an error correction decoding operation through the ECC decoder when errors equal to or greater than a reference value occur even though the read retry operation, which is a repeated read operation, has been performed using the plurality of read retry levels.

The memory interface 142 may serve as an interface for handling commands and data transferred between the controller 130 and the memory device 150, in order to allow the controller 130 to control the memory device 150 in response to a command or a request input from the host 102. The memory interface 142 may generate a control signal for the memory device 150 and may process data input to, or output from, the memory device 150 under the control of the processor 134 in a case when the memory device 150 is a flash memory.

For example, when the memory device 150 includes a NAND flash memory, the memory interface 142 includes a NAND flash controller (NFC). The memory interface 142 can provide an interface for handling commands and data between the controller 130 and the memory device 150. In accordance with an embodiment, the memory interface 142 can be implemented through, or driven by, firmware called a Flash Interface Layer (FIL) for exchanging data with the memory device 150.

According to an embodiment, the memory interface 142 may support an open NAND flash interface (ONFi), a toggle mode, or the like, for data input/output with the memory device 150. For example, the ONFi may use a data path (e.g., a channel, a way, etc.) that includes at least one signal line capable of supporting bi-directional transmission and reception in a unit of 8-bit or 16-bit data. Data communication between the controller 130 and the memory device 150 can be achieved through at least one interface regarding an asynchronous single data rate (SDR), a synchronous double data rate (DDR), a toggle double data rate (DDR), or the like.

The memory 144 may be used as a working memory of the storage device 110 or the controller 130, while temporarily storing transactional data for operations performed in the storage device 110 and the controller 130. For example, the memory 144 may temporarily store read data entries output from the memory device 150 in response to a read request from the host 102 before the read data entries are output to the host 102. In addition, the controller 130 may temporarily store write data entries input from the host 102 in the memory 144 before programming the write data entries in the memory device 150. When the controller 130 controls operations, such as a data read operation, a data write or program operation, a data erase operation, etc., of the memory device 150, data transmitted between the controller 130 and the memory device 150 of the storage device 110 may be temporarily stored in the memory 144.

In particular, as described with reference to FIG. 1, the memory 144 may include the update cache UPC for temporarily storing the updated data units UPDATED KPDATA1, UPDATED KPDATA2, UPDATED KPDATA3, and UPDATED KPDATA4 based on a request from the host 102, among the kept data units KPDATA1, KPDATA2, KPDATA3, KPDATA4, KPDATA5, KPDATA6, KPDATA7, and KPDATA8 that have been stored in the memory device 150, while a live migration operation is performed.

In an embodiment, the memory 144 may be implemented with a volatile memory. For example, the memory 144 may be implemented with a static random access memory (SRAM), a dynamic random access memory (DRAM), or both. Although FIG. 5 illustrates, for example, the memory 144 disposed within the controller 130, embodiments are not limited thereto. The memory 144 may be located within or external to the controller 130. For instance, the memory 144 may be embodied by an external volatile memory having a memory interface transferring data and/or signals between the memory 144 and the controller 130.

In addition to the read data entries or write data entries, the memory 144 may store information, e.g., map data, read requests, program requests, etc. used for inputting or outputting data between the host 102 and the memory device 150. According to an embodiment, the memory 144 may include one or more of a command queue, a program memory, a data memory, a write buffer/cache, a read buffer/cache, a data buffer/cache, a map buffer/cache, and so on. The controller 130 may allocate some storage space in the memory 144 for a component which is established to carry out a data input/output operation. For example, the write buffer established in the memory 144 may be used to temporarily store target data subject to a program operation.

The first processor 134 and the second processor 135 may control the overall operations of the storage device 110. For example, the first processor 134 and the second processor 135 can control a program operation or a read operation of the memory device 150 in response to a write request or a read request entered from the host 102.

According to an embodiment, the first processor 134 and the second processor 135 may execute firmware to control the program operation or the read operation in the storage device 110. Herein, the firmware may be referred to as a flash translation layer (FTL). An example of the FTL will be described in detail. According to an embodiment, the first processor 134 and the second processor 135 may be implemented with a microprocessor, a central processing unit (CPU), or the like.

According to an embodiment, the storage device 110 may be implemented with at least one multi-core processor. The multi-core processor is a type of circuit or chip in which two or more cores, which are considered distinct processing regions, are integrated. For example, when a plurality of cores in the multi-core processor drive or execute a plurality of flash translation layers (FTLs) independently, a data input/output speed (or performance) of the storage device 110 may be improved. According to an embodiment, the data input/output (I/O) operations in the storage device 110 may be independently performed through different cores in the multi-core processor.

The first processor 134 and the second processor 135 controls the entire operations of the storage device 110. In particular, the first processor 134 and the second processor 135 controls a program operation or a read operation for the memory device 150, in response to a write request or a read request from the host 102. The first processor 134 and the second processor 135 drives firmware which is referred to as a flash translation layer (FTL), to control general operations of the storage device 110. The first processor 134 and the second processor 135 may be realized by a microprocessor or a central processing unit (CPU).

For instance, the controller 130 performs an operation requested from the host 102, in the memory device 150. That is, the controller 130 performs a command operation corresponding to a command received from the host 102, with the memory device 150, through the first processor 134 and the second processor 135 embodied by a microprocessor or a central processing unit (CPU). The controller 130 may perform a foreground operation as a command operation corresponding to a command received from the host 102. For example, the controller 130 may perform a program operation corresponding to a write command, a read operation corresponding to a read command, an erase operation corresponding to an erase command.

The controller 130 may also perform a background operation for the memory device 150, through the first processor 134 and the second processor 135 embodied by a microprocessor or a central processing unit (CPU). The background operation for the memory device 150 may include an operation of copying data stored in a memory block among the memory blocks 152, 154 and 156 of the memory device 150 to another memory block, for example, a garbage collection (GC) operation. The background operation may include an operation of swapping data between one or more of the memory blocks 152, 154 and 156 of the memory device 150, for example, a wear leveling (WL) operation, a read reclaim (RR) operation and media scan operation.

The background operation may include an operation of storing map data retrieved from the controller 130 in the memory blocks 152, 154 and 156 of the memory device 150, for example, a map flush operation. The background operation may include a bad management operation for the memory device 150, which may include checking for and processing a bad block among the plurality of memory blocks 152, 154 and 156 in the memory device 150.

Referring to FIG. 5 along with FIG. 1, after the start of a live migration operation, the controller 130 may classify the kept data units KPDATA1, KPDATA2, KPDATA3, KPDATA4, KPDATA5, KPDATA6, KPDATA7, and KPDATA8 that have been stored in the memory device 150 into the plurality of groups GP1 and GP2 each including N kept data units, and may independently perform a selection operation on each group. In this case, the controller 130 may perform a selection operation corresponding to some data units, among the kept data units KPDATA1, KPDATA2, KPDATA3, KPDATA4, KPDATA5, KPDATA6, KPDATA7, and KPDATA8, through the first processor 134, and may perform a selection operation corresponding to the remaining data units except the some data units through the second processor 135.

For example, the controller 130 may perform a selection operation on data units that have been classified as the first group GP1, among the kept data units KPDATA1, KPDATA2, KPDATA3, KPDATA4, KPDATA5, KPDATA6, KPDATA7, and KPDATA8, through the first processor 134, and may perform a selection operation on data units that have been classified as the second group GP2 through the second processor 135.

Although various embodiments have been described for illustrative purposes, it will be apparent to those skilled in the art that various changes and modifications may be made without departing from the spirit and scope of the invention as defined in the following claims.

What is claimed is:

1. A storage device comprising:
a memory in which kept data units are stored; and
a controller configured to perform a migration operation of migrating the kept data units to an external storage device based on a request from a host,
wherein the controller
selects updated data units, from a plurality of kept data groups with N data units included in a kept data group for which an update check request has been made, by determining whether each of the N data units included in the kept data group has been updated when receiving the update check request for the plurality of kept data groups from the host,
performs a selection operation of storing the updated data units in an update cache,
predicts a kept data group for which an update check request is to be made next by the host, among the plurality of kept data groups, by analyzing the N data units, and
performs a selection operation on the kept data group for which the update check request is to be made next,
wherein N is a natural number equal to or greater than 2.

2. The storage device of claim 1, wherein the controller starts an execution of a selection operation for the kept data group for which the update check request is to be made next before receiving the next update check request after an execution of a selection operation for the kept data group for which the update check request has been made.

3. The storage device of claim 2, wherein the controller
manages each of the kept data units in units of a first size, and
manages the updated data units that have been stored in the update cache in units of a second size, which is greater than the first size, by setting the updated data units that have been merged by a predetermined number as a transmission data unit.

4. The storage device of claim 3, wherein the controller
performs a copy operation of migrating the transmission data unit to the external storage device, and
repeatedly performs an update processing loop comprising a plurality of selection operations and the copy operation for the plurality of kept data groups until the migration operation is completed.

5. The storage device of claim 4, wherein the controller
enters a down-time mode in which the update of the kept data units is prohibited when a number of updated data units that have been stored in the update cache is less than a critical number based on a selection operation that has been performed after a start of a live-time mode in which an access request for the kept data units from the host is permitted,
performs the update processing loop once, and
completes the migration operation.

6. The storage device of claim 4, wherein the controller
sets a first selection operation, among the plurality of selection operations included in a first update processing loop during the update processing loop that is repeatedly performed, and sets remaining selection operations except the first selection operation as a second selection operation, and
sets the plurality of selection operations included in a second update processing loop that is repeated until the migration operation is completed after the first update processing loop, during the update processing loop that is repeatedly performed.

7. The storage device of claim 4, wherein the controller
sets a first selection operation, among the plurality of selection operations included in each of update processing loops that are repeatedly performed, and
sets remaining selection operations except the first selection operation as a second selection operation.

8. The storage device of claim 2, wherein the controller
determines an update check prediction order by analyzing an update check order that has been applied to the selection operation for the kept data group for which the update check request has been made based on a first start logical address and a first end logical address corresponding to the update check request that is received from the host and that is included in the update check request, and
performs the selection operation for the kept data group for which the update check request is to be made next based on the update check prediction order.

9. The storage device of claim 8, wherein the controller
confirms physical locations corresponding to the N data units included in the kept data group for which the update check request has been made, which correspond to the first start logical address and the first end logical address, and
determines physical locations that are indicated by a second start logical address and a second end logical address to be included in the next update check request and that correspond to the N data units included in the kept data group for which the update check request is to be made next, among the plurality of kept data groups, based on the confirmed physical locations.

10. The storage device of claim 1, wherein:
the controller further comprises first and second processors, and
the controller performs the selection operation corresponding to some of the kept data units through the first processor, and performs the selection operation corresponding to remaining kept data units through the second processor.

11. An operating method of a storage device configured to perform a migration operation of migrating kept data units that have been stored in internal memory to an external storage device based on a request from a host, the operating method comprising:
selecting, when receiving an update check request for a plurality of kept data groups each comprising N data units from the host, updated data units, from among the N data units, by determining whether each of the N data units included in a kept data group for which the update check request has been made, among the plurality of kept data groups, has been updated;
performing a selection operation of storing the updated data units in an update cache;
predicting a kept data group for which an update check request is to be made next by the host, from among the plurality of kept data groups, by analyzing the N data units; and
performing the selection operation on the kept data group for which the update check request is to be made next,
wherein N is a natural number equal to or greater than 2.

12. The operating method of claim 11, further comprising starting an execution of the selection operation for the kept data group for which the update check request is to be made next, before the next update check request is received after an execution of the selection operation for the kept data group for which the update check request has been made is started.

13. The operating method of claim 12, further comprising:
managing each of the kept data units in units of a first size based on address mapping information, and
managing each of the updated data units that have been stored in the update cache in units of a second size that is greater than the first size by setting the updated data units that have been merged by a predetermined number as a transmission data unit based on transmission mapping information.

14. The operating method of claim 13, further comprising:
performing a copy operation of migrating the transmission data unit to the external storage device, and
repeatedly performing an update processing loop comprising a plurality of selection operations and copy operations for the plurality of kept data groups until the migration operation is completed.

15. The operating method of claim 14, further comprising:
setting a first selection operation, among the plurality of selection operations included in a first update processing loop during the update processing loop that is repeatedly performed, and setting remaining selection operations except the first selection operation as a second selection operation, and
setting each of the plurality of selection operations included in a second update processing loop that is repeated until the migration operation is completed after the first update processing loop, during the update processing loop that is repeatedly performed.

16. The operating method of claim 14, further comprising:
setting a first selection operation, among the plurality of selection operations included in each of update processing loops that are repeatedly performed, and
setting remaining selection operations except the first selection operation as a second selection operation.

17. The operating method of claim 12, wherein the predicting of the kept data group for which the update check request is to be made next by the host comprises:
determining an update check prediction order by analyzing an update check order that has been applied to the selection operation for the kept data group for which the update check request has been made based on a first start logical address and a first end logical address corresponding to the update check request included in the update check request from the host; and
performing the selection operation for the kept data group for which the update check request is to be made next based on the update check prediction order.

18. The operating method of claim 17, wherein the determining of the update check prediction order comprises:
confirming physical locations corresponding to the N data units included in the kept data group for which the update check request has been made, which correspond to the first start logical address and the first end logical address, and
determining physical locations that are indicated by a second start logical address and a second end logical address to be included in the next update check request and that correspond to the N data units included in the kept data group for which the update check request is to be made next, among the plurality of kept data groups, based on the confirmed physical addresses.
